(19) United States
(12) Patent Application Publication
(10) Pub. No.: US 2007/0266431 A1
(43) Pub. Date: Nov. 15, 2007

(54) Firewall Inspecting System and Firewall Information Extraction System

(75) Inventor: Katsushi Matsuda, Tokyo (JP)

Correspondence Address: FOLEY AND LARDNER LLP;SUITE 500, 3000 K STREET NW, WASHINGTON, DC, 20007, US

(73) Assignee: Nec Corporation

(21) Appl. No.: 11/666,861

(22) PCT Filed: Oct. 27, 2005
(86) PCT No.: PCT/JP05/19765

§ 371 Date: May 3, 2007

(30) Foreign Application Priority Data
Nov. 4, 2004 (JP) 2004-320788

(51) Int. Cl. G06F 9/00

(52) U.S. Cl. 726/13

(57) ABSTRACT

A firewall inspecting system is disclosed which prevents the network system of an organization under inspection services from suffering a failure or an undue load when the inspection services are provided to the network system. A policy extractor extracts a firewall policy from a firewall to be inspected, and converts the firewall policy in a non-unique policy independent of the type of the firewall. A communication unit of an inspecting system receives the non-unique policy from a client system. A virtual FW generator generates a virtual FW for emulating operation of the firewall, using the non-unique policy. A CPU which operates according to the virtual FW inspects the virtual FW by referring to an attribute of an inspection packet which has been generated in advance, and transmits an inspected result to the client system.

### TECHNICAL FIELD

The present invention relates to a firewall inspecting system for inspecting a firewall and a firewall information extracting system.

The present invention finds applications in the services for inspecting and correcting a firewall policy applied to a firewall.

### BACKGROUND ART

There is a growing interest in network security for organizations such as corporation or the like. One of the technologies for protecting the network of an organization (which is herein assumed to be a corporation) is a firewall. The firewall is a network device or a software implementation to be installed in a gateway or a router that connects the Internet and the corporate network to each other. The firewall protects the corporate network by inspecting packets flowing through the network and passing or blocking the inspected packets. The firewall inspects packets based on a firewall policy. The firewall policy refers to a collection of rules representing conditions for allowing packets to pass and conditions for blocking packets that depend on the attributes of the packets (source addresses and ports, destination addresses and ports, protocol types, etc.). For example, a rule specifies “a packet having a particular protocol which is heading for a particular port of the address of an open server in the corporate network shall be permitted to pass”.

Corporations which lack network security professionals and corporations which are not well organized to handle daily incidents, even if they have network security professionals, find it difficult to generate, maintain, and manage firewall policies. For this reason, many inspection services are increasingly popular for inspecting firewalls and open servers of client corporations by launching a pseudo attack on those corporate firewalls and open servers. Such an inspection is disclosed in Patent Document 1 and Patent Document 2.

Patent Document 1: JP-A No. 2001-337919

Patent Document 2: JP-A No. 2001-32338

### DISCLOSURE OF THE INVENTION

### Problems to be Solved by the Invention

The inspection services for launching a pseudo attack suffer the following problems:

Firstly, since a firewall or an open server as an object to be inspected is inspected by launching a pseudo attack thereon, the object to be inspected may possibly be damaged severely. Therefore, the network may possibly be disconnected temporarily, or the open server may possibly be shut down, so that the client corporation that obtains the inspection services may possibly suffer a shutdown of business or a loss of business opportunities. Secondly, the pseudo attack poses an increased load on the firewall and the open server, also tending to cause the client corporation to possibly suffer a slowdown of business or a loss of business opportunities. Thirdly, the service providing corporation which provides the inspection services is required to make the pseudo attack harmless. However, since the process of making the pseudo attack harmless needs a lot of man-hours, a time lag may occur from the time when a new attack is found until an inspection against the attack becomes possible, and the cost of the inspection services may be increased. In other words, the service providing corporation finds it difficult to handle incidents quickly and to provide low-cost inspection services. Fourthly, as the service providing corporation launches a pseudo attack directly on an object to be inspected of a client corporation, the attack method that has been made harmless and the inspection process themselves are accessible to the client corporation and may possibly be leaked through the client corporation to competitive corporations. Fifthly, information such as the firewall policy of the client corporation is unknown to the service providing corporation. Consequently, even if the firewall of the client corporation is in a state for passing more packets than necessary, the service providing corporation is unable to present specific measures for improving the firewall state to the client corporation.

It is an object of the present invention to prevent the network system of an organization that receives inspection services from suffering a failure or an undue load when the inspection services are provided to the network system. Another object of the present invention is to realize a capability for handling incidents quickly and a reduction in the costs of inspection services. Still another object of the present invention is to increase the secrecy of the inspection method of an inspection service provider. Yet another object of the present invention is to provide a capability for presenting specific measures for improving a state in which a firewall to be inspected is set to pass more packets than necessary.

### Means for Solving the Problems

According to an aspect of the present invention, a firewall inspecting system comprises:

policy extracting means for extracting a firewall policy, which represents a collection of rules representing conditions for allowing packets to pass and conditions for blocking packets, from a firewall;

converting means for converting the firewall policy extracted by the policy extracting means into a non-unique policy which is a firewall policy in a format that is independent of the type of the firewall;

inspection knowledge memory means for storing an inspection packet which is a packet used in an attack or a packet used in an attack which is exclusive of an attack code;

determining process executing means for executing a determining process to determine whether a given packet is allowed to pass or blocked based on the non-unique policy;

virtual firewall generating means for generating a virtual firewall which is a program for enabling the determining process executing means to execute the determining process, using the non-unique policy converted by the converting means;

inspecting means for reading the inspection packet from the inspection knowledge memory means, for controlling the determining process executing means to determine whether the inspection packet is allowed to pass or blocked according to the virtual firewall, and for obtaining a determined result and a rule which has led to the determined result; and

inspected result generating means for generating an inspected result by adding predetermined information to the rule, which has led to the determined result indicating that the inspection packet is allowed to pass, among rules included in the non-unique policy converted by the converting means.

Therefore, the firewall can be inspected without launching a pseudo attack by transmitting an inspection packet directly to the firewall. As a result, the firewall to be inspected is not damaged by a pseudo attack, and the owner of the firewall will not possibly suffer a shutdown of business or a loss of business opportunities. Furthermore, an increased load is not imposed on the owner of the firewall, who will not possibly suffer a slowdown of business or a loss of business opportunities.

The firewall inspecting system may further comprise inverse converting means for converting the non-unique policy included in the inspected result into a firewall policy in a format that depends on the type of the firewall, and result output means for outputting the firewall policy converted by the inverse converting means, together with the predetermined information.

The policy extracting means, the converting means, the inverse converting means, and the result output means may make up a firewall information extracting system for extracting a firewall policy from a firewall, and the inspection knowledge memory means, the determining process executing means, the virtual firewall generating means, the inspecting means, and the inspected result generating means may make up an inspecting system for inspecting the firewall. With this configuration, the owner of the inspecting system can keep a specific inspecting process secret from the owner of the firewall. Since the inspecting system inspects the firewall using the non-unique policy, it is not necessary to transmit a firewall policy in a format that depends on the firewall to the inspecting system. Consequently, the owner of the firewall can keep the type and version of the firewall secret from the owner of the inspecting system.

The policy extracting means and the result output means may make up a firewall information extracting system for extracting a firewall policy from a firewall, and the converting means, the inspection knowledge memory means, the determining process executing means, the virtual firewall generating means, the inspecting means, the inspected result generating means, and the inverse converting means may make up an inspecting system for inspecting the firewall. With this configuration, the owner of the inspecting system can keep a specific inspecting process secret from the owner of the firewall.

The determining process executing means may determine whether the inspection packet is allowed to pass or not based on whether or not attribute information stored in a portion of the inspection packet other than a payload thereof is in accordance with the rules in the non-unique policy. With this configuration, it is not necessary to make an attack code stored in the payload harmless. As a result, man-hours required for inspection services are eliminated, and a problem can be handled quickly. As man-hours are not required, the cost of the inspection services is reduced, and inexpensive firewall inspection services can be provided.

According to another aspect of the present invention, a firewall inspecting system comprises:

policy extracting means for extracting a firewall policy, which represents a collection of rules representing conditions for allowing packets to pass and conditions for blocking packets, from a firewall;

converting means for converting the firewall policy extracted by the policy extracting means into a non-unique policy which is a firewall policy in a format that is independent of the type of the firewall;

inspection correction knowledge memory means for storing an inspection packet which is a packet used in an attack or a packet used in an attack which is exclusive of an attack code, and correction guideline information for correcting a rule which passes the inspection packet in order to block the inspection packet;

determining process executing means for executing a determining process to determine whether a given packet is allowed to pass or blocked based on the non-unique policy;

virtual firewall generating means for generating a virtual firewall which is a program for enabling the determining process executing means to execute the determining process, using the non-unique policy converted by the converting means;

inspecting means for reading the inspection packet from the inspection correction knowledge memory means, for controlling the determining process executing means to determine whether the inspection packet is allowed to pass or blocked according to the virtual firewall, and for obtaining a determined result and a rule which has led to the determined result;

inspected result generating means for generating an inspected result by adding predetermined information to the rule which has led to the determined result indicating that the inspection packet is allowed to pass, among rules included in the non-unique policy converted by the converting means; and

correcting means for generating a rule for blocking the inspection packet based on the rule which has led to the determined result indicating that the inspection packet is allowed to pass, and on the correction guideline information corresponding to the inspection packet, and for correcting the non-unique policy by adding the rule to the non-unique policy.

Therefore, the firewall can be inspected without launching a pseudo attack by transmitting an inspection packet directly to the firewall. As a result, the firewall to be inspected is not damaged by a pseudo attack, and the owner of the firewall will not possibly suffer a shutdown of business or a loss of business opportunities. Furthermore, an increased load is not imposed on the owner of the firewall, who will not possibly suffer a slowdown of business or a loss of business opportunities. As the corrected firewall policy is output, even if the firewall is in a state for allowing more packets than necessary to pass, it is possible to provide a specific countermeasure for improving the state of the firewall to the owner of the firewall.

The firewall inspecting system may further comprise inverse converting means for converting the corrected non-unique policy into a firewall policy in a format that depends on the type of the firewall, and result output means for outputting the firewall policy converted by the inverse converting means.

The policy extracting means, the converting means, the inverse converting means, and the result output means may make up a firewall information extracting system for extracting a firewall policy from a firewall, and the inspection correction knowledge memory means, the determining process executing means, the virtual firewall generating means, the inspecting means, the inspected result generating means, and the correcting means may make up an inspecting system for inspecting the firewall. With this configuration, the owner of the inspecting system can keep a specific inspecting process secret from the owner of the firewall. Since the inspecting system inspects the firewall using the non-unique policy, it is not necessary to transmit a firewall policy in a format that depends on the firewall to the inspecting system. Consequently, the owner of the firewall can keep the type and version of the firewall secret from the owner of the inspecting system.

The policy extracting means and the result output means may make up a firewall information extracting system for extracting a firewall policy from a firewall, and the converting means, the inspection correction knowledge memory means, the determining process executing means, the virtual firewall generating means, the inspecting means, the inspected result generating means, the correcting means, and the inverse converting means may make up an inspecting system for inspecting the firewall. With this configuration, the owner of the inspecting system can keep a specific inspecting process secret from the owner of the firewall.

The firewall inspecting system may further comprise policy applying means for applying the firewall policy, converted by the inverse converting means, to the firewall.

The firewall inspecting system may further comprise non-unique policy memory means for storing the non-unique policy converted by the converting means, and instruction input means for entering an instruction to reapply the firewall policy to the firewall, wherein when the instruction is entered, the inverse converting means may convert the non-unique policy stored by the non-unique policy memory means into the firewall policy in a format that depends on the type of the firewall, and the policy applying means may apply the firewall policy converted by the inverse converting means to the firewall. With this configuration, the firewall policy can easily be restored when the firewall policy has been corrupted for some reason or when the type of firewall is changed, for example. Since the firewall policy can easily be restored even when the type of firewall is changed, firewall devices and firewall software can easily be changed.

The determining process executing means may determine whether the inspection packet is allowed to pass or not, based on whether or not attribute information stored in a portion of the inspection packet other than a payload thereof is in accordance with a rule in the non-unique policy. With this configuration, it is not necessary to make an attack code stored in the payload harmless. As a result, man-hours required for inspection services are eliminated, and a problem can be handled quickly. As man-hours are not required, the cost of the inspection services is reduced, and inexpensive firewall inspection services can be provided.

According to still another aspect of the present invention, a firewall information extracting system for extracting a firewall policy which represents a collection of rules representing conditions for allowing packets to pass and conditions for blocking packets, from a firewall, comprises:

policy extracting means for extracting a firewall policy from a firewall;

converting means for converting the firewall policy extracted by the policy extracting means into a non-unique policy which is a firewall policy in a format that is independent of the type of the firewall;

non-unique policy transmitting means for transmitting the non-unique policy converted by the converting means to an inspecting system for inspecting the firewall to enable the inspecting system to inspect the firewall; and

inspected result receiving means for receiving, from the inspecting system, an inspected result generated by adding predetermined information to a rule which allows an inspection packet to pass, among rules included in the non-unique policy.

The firewall information extracting system may further comprises inverse converting means for converting the non-unique policy included in the inspected result into a firewall policy in a format that depends on the type of the firewall, and result output means for outputting the firewall policy converted by the inverse converting means, together with the predetermined information.

According to yet another aspect of the present invention, a firewall information extracting system for extracting a firewall policy, which represents a collection of rules representing conditions for allowing packets to pass and conditions for blocking packets, from a firewall, comprises:

policy extracting means for extracting a firewall policy from a firewall;

converting means for converting the firewall policy extracted by the policy extracting means into a non-unique policy which is a firewall policy in a format that is independent of the type of the firewall;

non-unique policy transmitting means for transmitting the non-unique policy converted by the converting means to an inspecting system for inspecting the firewall to enable the inspecting system to correct the non-unique policy; and

corrected result receiving means for receiving the corrected non-unique policy from the inspecting system.

The firewall information extracting system may further comprise inverse converting means for converting the corrected non-unique policy into a firewall policy in a format that depends on the type of the firewall, and result output means for outputting the firewall policy converted by the inverse converting means.

The firewall information extracting system may further comprise policy applying means for applying the firewall policy converted by the inverse converting means to the firewall. With this configuration, the owner of the firewall itself may not need to carry out the task of applying the corrected firewall policy to the firewall.

The firewall information extracting system may further comprise non-unique policy memory means for storing the non-unique policy converted by the converting means; and instruction input means for entering an instruction to reapply the firewall policy to the firewall, wherein when the instruction is entered, the inverse converting means may convert the non-unique policy stored by the non-unique policy memory means into the firewall policy in a format that depends on the type of the firewall, and the policy applying means may apply the firewall policy converted by the inverse converting means to the firewall. With this configuration, the firewall policy can easily be restored when the firewall policy has been corrupted for some reason or when the type of firewall is changed, for example. Since the firewall policy can easily be restored even when the type of firewall is changed, firewall devices and firewall software can easily be changed.

According to still another aspect of the present invention, a firewall inspecting system for inspecting a firewall by receiving data from a firewall information extracting system for extracting a firewall policy from the firewall, comprises:

non-unique policy receiving means for receiving a non-unique policy which is a firewall policy in a format that is independent of the type of firewall, from the firewall information extracting system;

inspection knowledge memory means for storing an inspection packet which is a packet used in an attack or a packet used in an attack which is exclusive of an attack code;

determining process executing means for executing a determining process to determine whether a given packet is allowed to pass or blocked based on the non-unique policy;

virtual firewall generating means for generating a virtual firewall which is a program for enabling the determining process executing means to execute the determining process, using the non-unique policy received by the non-unique policy receiving means;

inspecting means for reading the inspection packet from the inspection knowledge memory means, for controlling the determining process executing means to determine whether the inspection packet is allowed to pass or blocked according to the virtual firewall, and for obtaining a determined result and a rule which led to the determined result;

inspected result generating means for generating an inspected result by adding predetermined information to the rule which has led to the determined result indicating that the inspection packet is allowed to pass, among rules included in the non-unique policy received by the non-unique policy receiving means; and

inspected result transmitting means for transmitting the inspected result to the firewall information extracting system.

According to a further aspect of the present invention, a firewall inspecting system for inspecting a firewall by receiving data from a firewall information extracting system for extracting a firewall policy from the firewall, comprises:

policy receiving means for receiving the firewall policy from the firewall information extracting system;

converting means for converting the firewall policy received by the policy receiving means into a non-unique policy which is a firewall policy in a format that is independent of the type of the firewall;

inspection knowledge memory means for storing an inspection packet which is a packet used in an attack or a packet used in an attack which is exclusive of an attack code;

determining process executing means for executing a determining process to determine whether a given packet is allowed to pass or blocked based on the non-unique policy;

virtual firewall generating means for generating a virtual firewall which is a program for enabling the determining process executing means to execute the determining process, using the non-unique policy converted by the converting means;

inspecting means for reading the inspection packet from the inspection knowledge memory means, for controlling the determining process executing means to determine whether the inspection packet is allowed to pass or blocked according to the virtual firewall, and for obtaining a determined result and a rule which has led to the determined result; and

inspected result generating means for generating an inspected result by adding predetermined information to the rule which has led to the determined result indicating that the inspection packet is allowed to pass, among rules included in the non-unique policy converted by the converting means.

The firewall inspecting system may further comprise inverse converting means for converting the non-unique policy included in the inspected result into a firewall policy in a format that depends on the type of the firewall, and result output means for outputting the firewall policy converted by the inverse converting means, together with the predetermined information.

According to still a further aspect of the present invention, a firewall inspecting system for inspecting a firewall by receiving data from a firewall information extracting system for extracting a firewall policy from the firewall, comprises:

non-unique policy receiving means for receiving a non-unique policy, which is a firewall policy in a format that is independent of the type of the firewall, from the firewall information extracting system;

inspection correction knowledge memory means for storing an inspection packet which is a packet used in an attack or a packet used in an attack which is exclusive of an attack code, and correction guideline information for correcting a rule which allows the inspection packet to pass in order to block the inspection packet;

determining process executing means for executing a determining process to determine whether a given packet is allowed to pass or blocked based on the non-unique policy;

virtual firewall generating means for generating a virtual firewall which is a program for enabling the determining process executing means to execute the determining process, using the non-unique policy received by the non-unique policy receiving means;

inspecting means for reading the inspection packet from the inspection correction knowledge memory means, for controlling the determining process executing means to determine whether the inspection packet is allowed to pass or blocked according to the virtual firewall, and for obtaining a determined result and a rule which has led to the determined result;

inspected result generating means for generating an inspected result by adding predetermined information to the rule which has led to the determined result indicating that the inspection packet is allowed to pass, among rules included in the non-unique policy received by the non-unique policy receiving means;

correcting means for generating a rule for blocking the inspection packet based on the rule which has led to the determined result indicating that the inspection packet is allowed to pass, and on the correction guideline information that corresponds to the inspection packet, and for correcting the non-unique policy by adding the rule to the non-unique policy; and

corrected result transmitting means for transmitting the corrected non-unique policy to the firewall information extracting system.

According to yet a further aspect of the present invention, a firewall inspecting system for inspecting a firewall by receiving data from a firewall information extracting system for extracting a firewall policy from the firewall, comprises:

policy receiving means for receiving the firewall policy from the firewall information extracting system;

converting means for converting the firewall policy received by the policy receiving means into a non-unique policy which is a firewall policy in a format that is independent of the type of the firewall;

inspection correction knowledge memory means for storing an inspection packet which is a packet used in an attack or a packet used in an attack which is exclusive of an attack code, and correction guideline information for correcting a rule which allows the inspection packet to pass in order to block the inspection packet;

determining process executing means for executing a determining process to determine whether a given packet is allowed to pass or blocked based on the non-unique policy;

virtual firewall generating means for generating a virtual firewall which is a program for enabling the determining process executing means to execute the determining process, using the non-unique policy converted by the converting means;

inspecting means for reading the inspection packet from the inspection correction knowledge memory means, for controlling the determining process executing means to determine whether the inspection packet is allowed to pass or blocked according to the virtual firewall, and for obtaining a determined result and a rule which has led to the determined result;

inspected result generating means for generating an inspected result by adding predetermined information to the rule, which has led to the determined result indicating that the inspection packet is allowed to pass, among rules included in the non-unique policy received by the non-unique policy receiving means; and

correcting means for generating a rule for blocking the inspection packet based on the rule which has led to the determined result indicating that the inspection packet is allowed to pass, and on the correction guideline information that corresponds to the inspection packet, and for correcting the non-unique policy by adding the rule to the non-unique policy.

The firewall inspecting system may further comprise inverse converting means for converting the corrected non-unique policy into a firewall policy in a format that depends on the type of the firewall, and corrected policy transmitting means for transmitting the firewall policy converted by the inverse converting means to the firewall information extracting system.

The determining process executing means may determine whether the inspection packet is allowed to pass or not, based on whether or not attribute information stored in a portion of the inspection packet other than a payload thereof is in accordance with a rule in the non-unique policy. With this configuration, it is not necessary to make an attack code stored in the payload harmless. As a result, man-hours required for inspection services are eliminated, and a problem can be handled quickly. As man-hours are not required, the cost of the inspection services is reduced, and inexpensive firewall inspection services can be provided.

### BRIEF DESCRIPTION OF THE DRAWINGS

FIG. 1 is a block diagram showing a first embodiment of the present invention;

FIG. 2 is a block diagram showing an example of the configuration of a client system and an inspecting system according to the first embodiment of the present invention;

FIG. 3 is a diagram illustrative of a virtual FW;

FIG. 4 is a flowchart showing an operation sequence of a firewall inspecting system according to the first embodiment of the present invention;

FIG. 5 is a block diagram showing a modification of the first embodiment of the present invention;

FIG. 6 is a block diagram showing an example of the configuration of a client system and an inspecting system according to a second embodiment of the present invention;

FIG. 7 is a flowchart showing an operation sequence of a firewall inspecting system according to the second embodiment of the present invention;

FIG. 8 is a block diagram showing a modification of the second embodiment of the present invention;

FIG. 9 is a diagram showing an example of an inherent policy and a non-inherent policy;

FIG. 10 is a diagram showing an example of information stored in a policy memory means of the client system;

FIG. 11 is a diagram showing an example of information stored in a policy memory means of the inspecting system;

FIG. 12 is a diagram showing an example of inspection knowledge stored in an inspection knowledge DB;

FIG. 13 is a flowchart of a process of determining whether a packet is allowed to pass or not;

FIG. 14 is a diagram showing an example of a non-inherent policy contained in a virtual FW;

FIG. 15 is a diagram showing an example of inspected results;

FIG. 16 is a diagram showing an example of an inherent policy converted from a non-inherent policy;

FIG. 17 is a diagram illustrative of a situation wherein a virtual FW is generated and an inspection is performed for each client corporation;

FIG. 18 is a diagram showing an example of inspection correction knowledge stored in an inspection correction knowledge DB;

FIG. 19 is a flowchart of a process of correcting the non-inherent policy;

FIG. 20 is a diagram showing an example of a corrected result of the non-inherent policy; and

FIG. 21 is a diagram showing an example of an inherent policy converted from the corrected result of the non-inherent policy.

### DESCRIPTION OF REFERENCE CHARACTERS

10 Client corporation network
20 Service providing corporation
100 Client system (firewall information extracting system)
110 Policy extractor
120 Policy conversion rule memory
130 Policy memory
140 Communication unit
150 Policy inverse converter
160 Result display unit
200 Inspecting system
210 Communicating means
220 Policy memory
230 Virtual FW generator
240 Virtual FW memory
250 FW inspector
260 Inspection knowledge DB
300 Firewall
400 Internet
1001-1008a, 1051-1059, 1071-1076 Steps

### BEST MODE FOR CARRYING OUT THE INVENTION

### 1st Embodiment

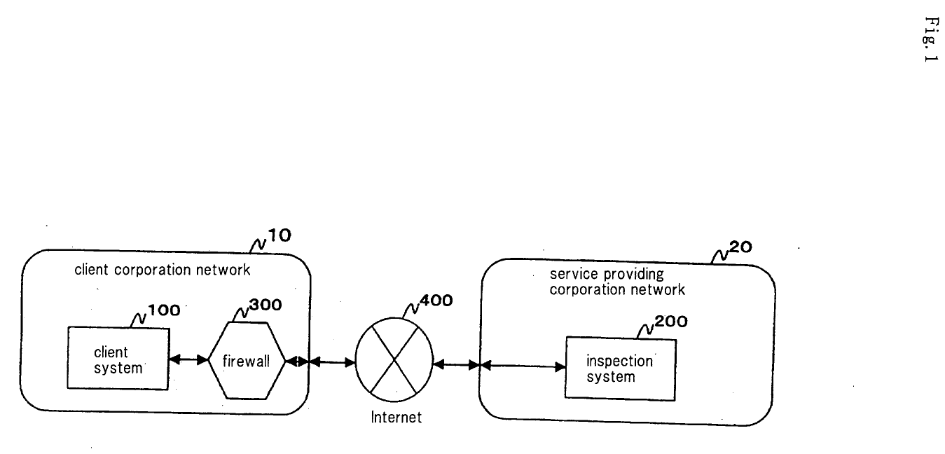

Referring to FIG. 1, a firewall inspecting system according to a first embodiment of the present invention has firewall information extracting system (hereinafter referred to as a client system) 100 and inspecting system 200. Client system 100 and inspecting system 200 are connected to each other by way of communication network 400. In the following, communication network 400 is assumed to be the Internet. Inspecting system 200 receives a firewall policy from client system 100, and inspects a firewall based on the firewall policy. Inspecting system 200 transmits the inspected result to client system 100.

An entity that receives firewall inspection services (which will be referred to as a client corporation, but is not limited to a corporation) has client corporation network 10 that is a communication network of the client corporation itself. The client corporation also has firewall 300 that connects Internet 400 and client corporation network 10 to each other. The client corporation purchases client system 100 from an entity that provides inspection services (which will be referred to as a service providing corporation, but is not limited to a corporation), and connects client system 100 to client corporation network 10. Client system 100 is connected to a network segment that is capable of accessing firewall 300.

The service providing corporation has service providing corporation network 20 that is a communication network of the service providing corporation itself. Inspecting system 20 is managed by the service providing corporation, and is connected to service providing corporation network 20. Although not shown, inspecting system 20 is connected to Internet 400 through a gateway, a router, etc.

The client corporation receives inspection services for inspecting firewall 300, and pays the service providing corporation for the inspection services.

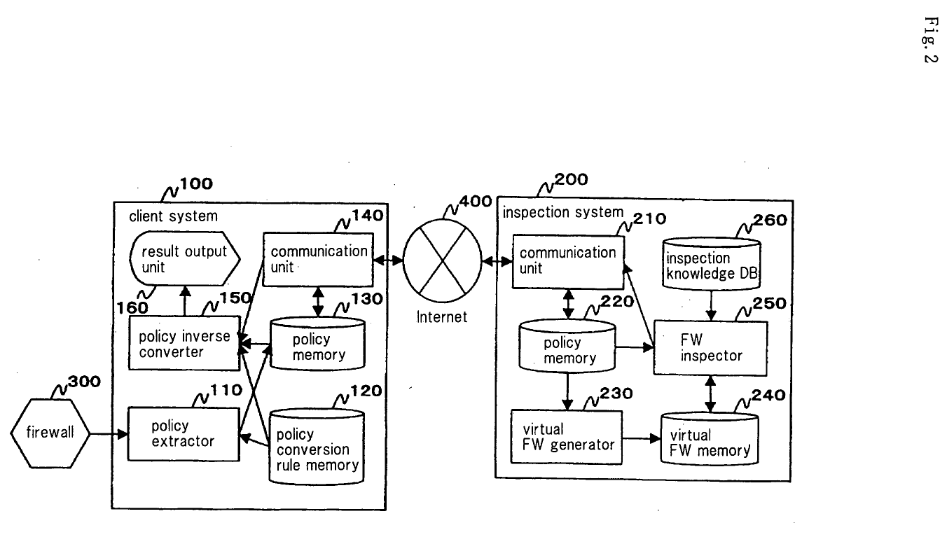

FIG. 2 is a block diagram showing an example of the configuration of client system 100 and inspecting system 200 according to the first embodiment. In FIG. 2, client system 100 and inspecting system are shown as being directly connected to the Internet, for the sake of convenience. However, as shown in FIG. 1, client system 100 is connected to Internet 400 through the firewall, and inspecting system 200 is connected to Internet 400 through the gateway, the router, etc. (not shown).

As shown in FIG. 2, client system 100 has policy extractor 110, policy conversion rule memory 120, policy memory 130, communication unit 140, policy inverse converter 150, and result output unit 160.

Policy extractor 110 extracts setting information from firewall 300. The setting information is information including a firewall policy, which is a collection of rules representing conditions for allowing packets to pass and conditions for blocking packets. According to the present embodiment, the setting information includes, in addition to the firewall policy, information about the type (product name, etc) and version of firewall 300. The firewall policy included in the setting information is described in a format that depends on firewall 300. Policy extractor 110 converts the firewall policy included in the extracted setting information into a firewall policy described in a format that depends on the type of the firewall, according to policy conversion rules. The policy conversion rules are an association table for converting a firewall policy in a format that depends on the type of the firewall (hereinafter referred to as unique policy) into a firewall policy in a format that is independent of the type of the firewall (hereinafter referred to as non-unique policy), and is stored in policy conversion rule memory 120 in association with the type and version of the firewall. Policy extractor 110 stores the converted non-unique policy, information as to the type and version of the firewall 300, the time at which the setting information is extracted, etc. in policy memory 130.

Policy conversion rule memory 120 stores, in advance, policy conversion rules for each of the firewall types.

Policy memory 130 stores the non-unique policy converted by policy extractor 110, the information about the type and version of the firewall, the time and date at which the setting information is extracted (which may be the time and date at which the setting information is stored in policy memory 130), etc.

Communication unit 140 reads a non-unique policy from policy memory 130 and transmits the non-unique policy to inspecting system 200. At this time, communication unit 140 adds a number, which becomes a serial number each time communication unit 140 transmits a non-unique policy, to the non-unique policy. Communication unit 140 associates the number and the information about the type and version of firewall 300, with each other, and stores them in policy memory 130, for example. Communication unit 140 receives the result of an inspection, which has been conducted on firewall 300 using the non-unique policy, from inspecting system 200. The inspected result represents a rule for allowing a packet that is attacking the firewall to pass, among the rules included in the non-unique policy, with the title of the attack being added to the rule.

Policy inverse converter 150 converts the non-unique policy included in the inspected result in a unique policy based on the policy conversion rules. Policy inverse converter 150 leaves the title of the attack added to the inspected result as it is. The number which was added to the non-unique policy when communication unit 140 transmitted the non-unique policy remains as it is in the inspected result. Based on the number, policy inverse converter 150 may specify the information about the type and version of the firewall, refer to the policy conversion rules that depend on the type of the firewall, and convert the non-unique policy into a unique policy based on the policy conversion rules. Policy inverse converter 150 controls result output unit 160 to output the unique policy with the title of the attack added thereto.

Result output unit 160 outputs the unique policy that was converted from the inspected result by policy inverse converter 150.

Policy extractor 110 and communication unit 140 may be implemented by an interface of client corporation network 10 (see FIG. 1) and a CPU that operates according to a program, for example. Policy conversion rule memory 120 and policy memory 130 may be implemented by a memory which client system 100 has, for example. Policy inverse converter 150 may be implemented by a CPU that operates according to a program, for example. The program may be stored, in advance, in a memory (not shown) which client system 100 has. Result output unit 160 may be implemented by a display unit or a printer unit.

As shown in FIG. 2, inspecting system 200 has communication unit 210, policy memory 220, virtual FW (firewall) generator 230, virtual FW (firewall) memory 240, FW (firewall) inspector 250, and inspection knowledge DB (database) 260.

Communication unit 210 receives a non-unique policy from client system 100, and stores the non-unique policy in policy memory 220. Communication unit 210 also transmits the inspected result to client system 100.

Policy memory 220 stores therein the non-unique policy which communication unit 210 has received from client system 100.

Virtual FW generator 230 generates a virtual FW and stores the virtual FW in virtual FW memory 240. The virtual FW is a program that causes a CPU (not shown) of inspecting system 200 to simulate operation of a firewall.

Stated otherwise, the virtual FW is a program that emulates firewall operation. Simulating operation of a firewall is equivalent to determining whether a given packet is allowed to pass or blocked thereby.

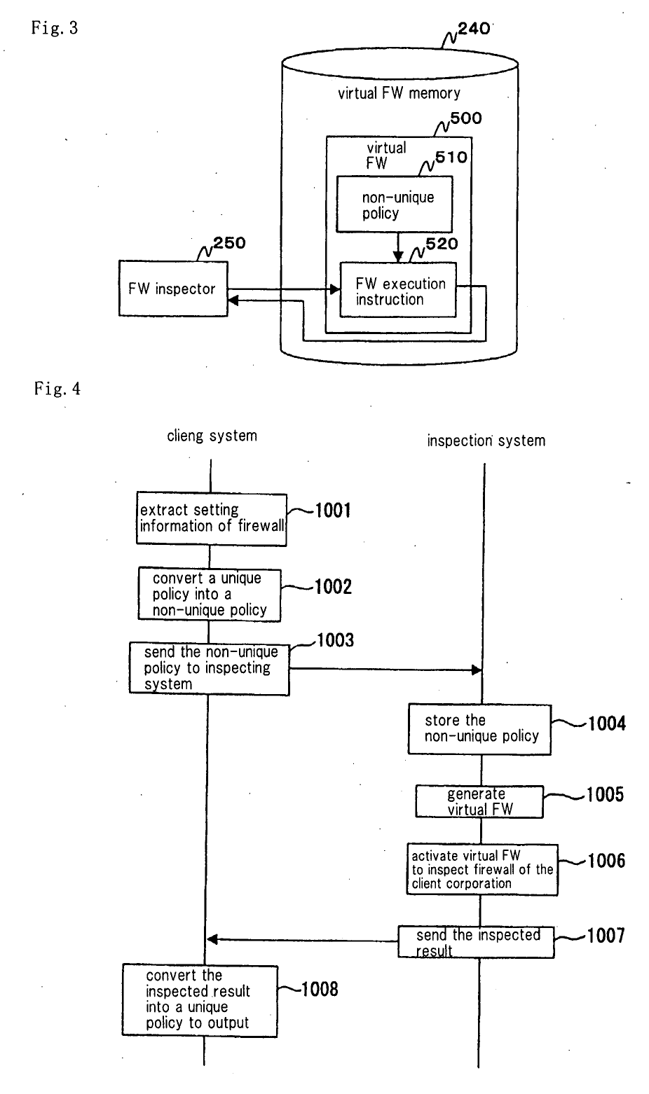

Virtual FW memory 240 stores the generated virtual FW. FIG. 3 is a diagram illustrative of a virtual FW. Virtual FW generator 230 generates virtual FW 500 by adding non-unique policy 510 to FW execution instruction 520 which has been prepared in advance. FW execution instruction 520 is an instruction group for controlling the CPU (not shown) of inspecting system 200 to perform operation of a firewall. FW execution instruction 520 is stored in a memory (not shown) of inspecting system 200, for example. Virtual FW generator 230 reads FW execution instruction 520, also reads a non-unique policy stored in policy memory 220, adds the read non-unique policy as non-unique policy 510 to FW execution instruction 520, thereby generating virtual FW 500. Virtual FW 500 is generated as a program execution file, for example. Virtual FW 500 which is generated as a program execution file may include the non-unique policy therein. Alternatively, the non-unique policy may be provided as a file different from the program execution file, and the data file of the non-unique policy may be associated with the program execution file.

Inspection knowledge DB 260 stores at least one data representing an attack itself or at least one data representing an attribute of an attack. Data representing an attack itself means an entire packet which attacks the system. Data representing an attack itself includes an attack code for causing the system to malfunction. The attack code is stored in the payload of the packet. Data representing an attribute of an attack means data that excludes an attack code (payload) from data representing an attack itself. Inspection knowledge DB 260 may store data including an attack code (data representing an attack itself or data excluding an attack code (data representing an attribute of an attack). Inspection knowledge DB 260 may store the title of an attack and supplemental matter (e.g., information as to what device will be infected). Data representing an attack itself, data representing an attribute of the attack, and the title of the attack are collectively referred to as inspection knowledge. If supplemental matter is present, then the supplemental matter is included in inspection knowledge. However, supplemental matter may be dispensed with. In the following, an entire packet which attacks the system or such a packet from which an attack code is excluded is referred to as an inspection packet.

Inspection knowledge DB 260 stores one or more items of inspection knowledge. Inspection knowledge is generated by the operator or security experts of the inspecting system of the service providing corporation. Alternatively, inspection knowledge may be sold to the service providing corporation by a security vendor or a corporation which manages problem information. Inspection knowledge is entered in inspecting system 200 through an input device (not shown) and stored in inspection knowledge DB 260 by a CPU (not shown).

FW inspector 250 activates virtual FW 500 stored in virtual FW memory 240. FW inspector 250 reads an inspection packet (which may not store an attack code in its payload) from inspection knowledge DB 260, and controls a CPU (not shown) which operates according to virtual FW 500 to determine whether the inspection packet is allowed to pass or not, and also to identify a rule which has led to the determined result. FW inspector 250 adds the attack title of the inspection packet which has been determined as being allowed to pass to the rule in the non-unique policy stored in policy memory 220.

Communication unit 210 may be implemented by an interface of service providing corporation 20 (see FIG. 1) and a CPU that operates according to a program, for example. Virtual FW generator 230 and FW inspector 250 may be implemented by a CPU that operates according to a program, for example. The program may be stored, in advance, in a memory (not shown) which inspecting system 200 has. Policy memory 220, virtual FW memory 240, and inspection knowledge DB 260 may be implemented by the memory which inspecting system 200 has.

Operation of the present embodiment will now be described below.

Before the firewall inspecting system starts to operate, the service providing corporation sells client system 100 to the client corporation. In client corporation network 10 (see FIG. 1), client system 100 is connected to a network segment that is capable of accessing firewall 300.

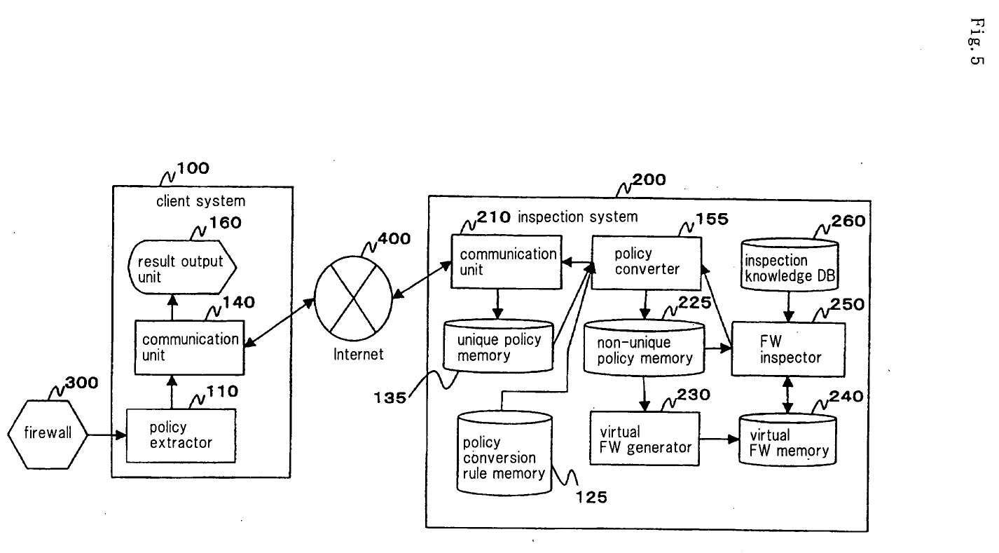

FIG. 4 is a flowchart showing an operation sequence of the firewall inspecting system according to the present embodiment. Policy extractor 110 of client system 100 extracts setting information of firewall 300 (step 1001). In step 1001, policy extractor 110 may extract setting information by executing a setting information acquiring command provided in firewall 300, for example. Alternatively, policy extractor 110 may extract setting information periodically from firewall 300, for example. Further alternatively, for example, client system 100 may have an input device (not shown) such as a keyboard, a mouse, or the like for entering commands from the operator, and policy extractor 110 may extract setting information from firewall 300 when an instruction to extract setting information is entered from the input device. Further alternatively, for example, policy extractor 110 may be preset to start a setting information extracting process at a time determined by a contract between the client corporation and the service providing corporation.

After step 1001, policy extractor 110 converts a unique policy included in the setting information into a non-unique policy, and stores the non-unique in policy memory 130 (step 1002). In step 1002, policy extractor 110 reads a policy conversion rule that corresponds to the information about the type and version of firewall 300 included in the setting information, from policy conversion rule memory 120. Then, policy extractor 110 converts a unique policy described in a format that depends on the type of the firewall, into a non-unique policy described in a format that is independent of the type of the firewall. When policy extractor 110 stores the non-unique policy in policy memory 130, policy extractor 110 also stores the time and date at which the setting information is extracted (which may be the time and date at which the setting information is stored in policy memory 130), together with information about the type and version of firewall 300.

In the present embodiment, although the information about the type and version of the firewall is included in the setting information, the information about the type and version of the firewall may not be included in the setting information. In this case, client system 100 may be supplied, in advance, with the information about the type and version of the firewall entered by the operator of the client corporation through an input device (not shown) such as a keyboard or the like, and may store the entered information in the memory (not shown). Then, policy extractor 110 may read the stored information about the version, etc. in step 1002, and may store the information together with the non-unique policy in policy memory 130. Alternatively, policy extractor 110 may acquire the information about the type and version from firewall 300 by executing a data acquiring command (a command for acquiring the information about the type and version of the firewall) provided in firewall 300.

After step 1002, communication unit 140 reads the non-unique policy from policy memory 130, and transmits the non-unique policy through Internet 400 to inspecting system 200 (step 1003). In step 1003, communication unit 140 adds a number, which becomes a serial number each time communication unit 140 transmits a non-unique policy, to the non-unique policy. Communication unit 140 associates the number added to the non-unique policy and the information about the type and version of firewall 300, with each other, and stores them in policy memory 130, for example. The serial number will be used to specify a policy conversion rule to refer to when the inspected result will subsequently be converted into a unique policy.

In step 1003, communication 140 may first transmit an inspection request to inspecting system 200 and then transmit the non-unique policy after it has received a reply indicating acceptance of the inspection request from inspecting system 200.

Communication unit 210 of inspecting system 200 receives the non-unique policy transmitted from communication unit 140 of client system 100, and stores the non-unique policy in policy memory 220 (step 1004).

Subsequently, virtual FW generator 230 reads FW execution instruction 520 from the memory (not shown) of inspecting system 200, for example. In step 1004, virtual FW generator 230 reads the non-unique policy stored in policy memory 220. Virtual FW generator 230 adds the non-unique policy to FW execution instruction 520 which has been read, thereby generating virtual FW 500 (step 1005). For example, virtual FW generator 230 generates virtual FW 500 as a program execution file including FW execution instruction 520 and non-unique policy 510 (which is the non-unique policy read from policy memory 220). Virtual FW generator 230 stores generated virtual FW 500 in virtual FW memory 240.

Then, FW inspector 250 activates virtual FW 500 to inspect firewall 300 of the client corporation (step 1006). Herein, it is assumed that the CPU (not shown) of inspecting system 200 which executes operation of a firewall according to virtual FW 500 and the CPU (not shown) which operates as FW inspector 250 are identical to each other. FW inspector 250 reads data representing an attack itself (an entire packet which attacks the system) or data representing an attribute of an attack (a packet excluding an attack code), from inspection knowledge DB 260. Then, FW inspector 250 controls the CPU (not shown) which operates according to virtual FW 500 to determine whether the packet is allowed to pass or not. The CPU which operates according to virtual FW 500 determines whether firewall 300 allows the packet to pass or blocks the packet, based on non-unique policy 510 included in virtual FW 500 and the attribute of the attack. If it is determined that the packet is allowed to pass, then FW inspector 250 adds the attack title of the packet to the rule which has led to the determined result that the packet is allowed to pass, among the rules included in the non-unique policy stored in policy memory 220. FW inspector 250 performs the above process for each of the data representing attacks themselves and the data representing the attributes of the attacks, which are stored in inspection knowledge DB 260.

The non-unique policy stored in step 1004 and the information about the attack (the title of the attack in the present embodiment) added thereto make up an inspected result. The inspected result also includes the number added to the non-unique policy in step 1003.

FW inspector 250 transmits the inspected result to communication unit 210 of inspecting system 200. Communication unit 210 transmits the inspected result through Internet 400 to client system 100 (step 1007).

Communication unit 140 of client system 100 receives the inspected result from communication unit 210 of inspecting system 200, and transfers the inspected result to policy inverse converter 150. Alternatively, communication unit 140 may store the inspected result in policy memory 130, and policy inverse converter 150 may read the inspected result from policy memory 130. Policy inverse converter 150 identifies the information about the type and version of the firewall that corresponds to the number included in the inspected result (the number added to the non-unique policy in step 1003), based on the information stored in step 1003. Policy inverse converter 150 reads the policy conversion rule that depends on the specified information from policy conversion rule memory 120. Policy inverse converter 150 converts the non-unique policy included in the inspected result into a unique policy in a format that depends on firewall 300, by referring to the policy conversion rule. Policy inverse converter 150 controls result output unit 160 to output (e.g., display) the converted unique policy, together with the information of the attack added in step 1006. As a result, the rule which allows the attacking packet to pass, among the rules included in the firewall policy of firewall 300, is presented to the operator of the client corporation.

In the present embodiment, a policy extracting means and a converting means collectively correspond to policy extractor 110. An inspection knowledge memory means corresponds to inspection knowledge DB 260. A determining process executing means corresponds to the CPU (not shown) of inspecting system 200. A virtual firewall generating means corresponds to virtual FW generator 230. An inspecting means and an inspected result generating means collectively correspond to FW inspector 250. An inverse converting means corresponds to policy inverse converter 150. A result output means corresponds to result output unit 160. A non-unique policy transmitting means and an inspected result receiving means collectively correspond to communication unit 140 of client system 100. A non-unique policy receiving means and an inspected result transmitting means collectively correspond to communication unit 210 of inspecting system 200.

Advantages of the present embodiment will be described below. According to the present embodiment, firewall 300 of the client corporation is not inspected per se, but inspecting system 200 of the service providing corporation generates virtual FW 500 (see FIG. 3) using the non-unique policy of firewall 300 and inspects virtual FW 500. Even if an attacking packet is given to the CPU (not shown) of inspecting system 200 which simulates operation of a firewall according to virtual FW 500, it does not adversely affect firewall 300 of the client corporation at all. Therefore, the client corporation will not possibly suffer a shutdown of business or a loss of business opportunities which would otherwise occur due to damage to firewall 300. Furthermore, since firewall 300 and client corporation network 10 (see FIG. 1) are not placed under a high load, the client corporation will not possibly suffer a slowdown of business or a loss of business opportunities.

The CPU (not shown) in inspection system 200 which operates according to virtual FW 500 determines whether firewall 300 allows the packet to pass or blocks the packet, based on non-unique policy 510 included in virtual FW 500 and the attribute of the attack. The determining process can be performed even if no attack code is included in the packet. Therefore, if a new attack is discovered and a pseudo attack is to be launched based on the new attack, man-hours for making the pseudo attack harmless is not required. Consequently, the service providing corporation can handle a problem quickly. In other words, when a new attack is discovered, the service providing corporation can quickly provide inspection services for the attack. As the man-hours for making the pseudo attack harmless is not required, the service providing corporation can lower the cost of its services and can provide inexpensive firewall inspection services to the client corporation.

Data representing an attack itself or data representing an attribute of an attack, which is stored in inspection knowledge DB 260, is used by inspecting system 200, and is not transmitted to client system 100. Therefore, data used for inspection, which is held by the service providing corporation itself, will not possibly be leaked through the client corporation to competitor corporations.

Client system 100 transmits a non-unique policy rather than a unique policy. Further, client system 100 does not transmit the information about the type and version of firewall 300, but client system 100 itself transmit a number that is associated with the invention by client system 100. Therefore, inspecting system 200 cannot identify the type and version of firewall 300 used by the client corporation. The client corporation which should keep secret the type and version of firewall 300 owned thereby can receive inspection services without the information about the type and version of firewall 300 being known to the service providing corporation know.

Virtual FW generator 230 may start generating a virtual FW (step 1005) after step 1004 is finished and when it is instructed to start to generate a virtual FW by the operator of the service providing corporation. Similarly, FW inspector 250 may start inspecting a firewall (step 1006) after step 1005 is finished and when it is instructed to start to inspect a firewall by the operator of the service providing corporation. In this case, the inspecting system has an input device (not shown) such as a keyboard, a mouse, or the like for entering commands from the operator. The operator can perform steps 1005, 1006 together according to batch processing when the number of non-unique policies stored in policy memory 220 has increased. Alternatively, during maintenance for storing new data in inspection knowledge DB 260, the operation may be interrupted in step 1004, and the operation from step 1005 may be resumed after the storage of new data in inspection knowledge DB 260 is finished.

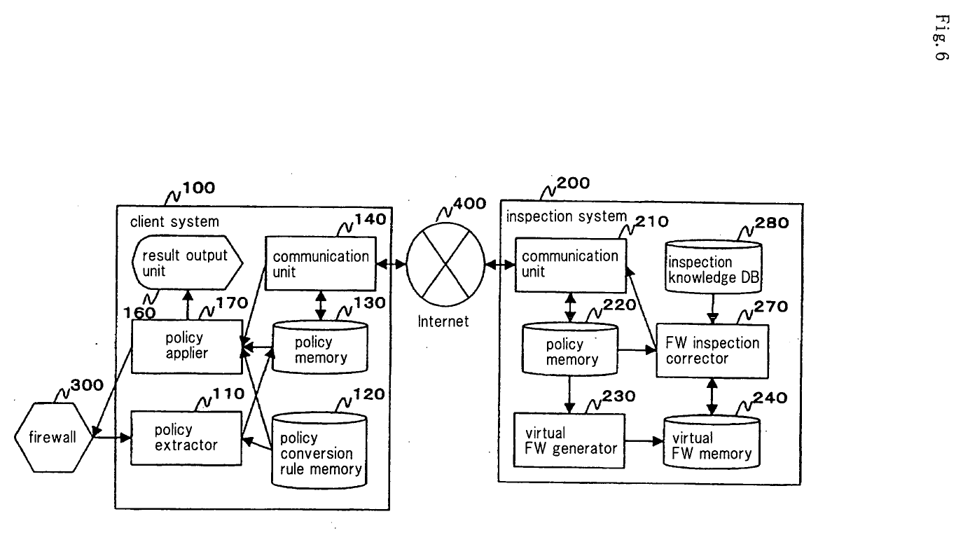

If the client corporation provides for disclosing the firewall policy and the type and version of firewall 300, then the client corporation may transmit the disclosed information to inspecting system 200, and inspecting system 200 may convert the unique policy into a non-unique policy. FIG. 5 shows a modification of the present embodiment in which a unique policy in a format that depends on the type of the firewall and the information about the type and version of the firewall are transmitted to inspecting system 200.

According to the modification, client system 100 has policy extractor 110, communication unit 140, and result output unit 160. Result output unit 160 is identical to result output unit 160 shown in FIG. 2.

Policy extractor 110 extracts setting information from firewall 300, and transmits a firewall policy (unique policy) and the information about the type and version of firewall 300, which are included in the setting information, to communication unit 140. The information about the type and version of firewall 300 may be entered in advance by the operator of the client corporation. Policy extractor 110 may extract the information about the type and version from firewall 300 separately from the setting information.

Communication unit 140 of client system 100 transmits the unique policy and the information about the type and version of firewall 300, which have been transmitted from policy extractor 110, to inspecting system 200. When communication unit 140 receives an inspected result from inspecting system 200, communication unit 140 controls result output unit 160 to output (e.g., display) the inspected result.

According to the modification, inspecting system 200 has communication unit 210, policy conversion rule memory 125, unique policy memory 135, policy converter 155, non-unique policy memory 225, virtual FW generator 230, virtual FW memory 240, FW inspector 250, and inspection knowledge DB 260. Policy conversion rule memory 125 stores policy conversion rules as does policy conversion rule memory 120 shown in FIG. 1. Virtual FW generator 230, virtual FW memory 240, FW inspector 250, and inspection knowledge DB 260 are identical respectively to virtual FW generator 230, virtual FW memory 240, FW inspector 250, and inspection knowledge DB 260 shown in FIG. 1. Non-unique policy memory 225 stores a non-unique policy memory as does policy memory 220 of inspecting system 200 shown in FIG. 1.

Communication unit 210 of inspecting system 200 stores the unique policy and the information about the type and version of firewall 300, which have been received from client system 100, in unique policy memory 135. Communication unit 210 may also store the time at which the unique policy was received in unique policy memory 135. Communication unit 210 may associate a number or the like for identifying each unique policy with the unique policy and store them in unique policy memory 135.

Unique policy memory 135 stores the unique policy and the information about the type and version of firewall 300 therein.

Policy converter 155 converts a unique policy into a non-unique policy and vice versa, by referring to the policy conversion rules. After the unique policy has been stored in unique policy memory 135 by communication unit 210, policy converter 155 reads a policy conversion rule that depends on the type and version of the firewall stored together with the unique policy, from policy conversion rule memory 125. Based on the policy conversion rule, policy converter 155 converts the unique policy stored in unique policy memory 135 into a non-unique policy, and stores the non-unique policy in non-unique policy memory 225. The information (the number or the like) added to identify each unique policy is also added to the converted non-unique policy.

After the non-unique policy has been stored in non-unique policy memory 225, virtual FW generator 230 generates virtual FW 300 (see FIG. 3) in the same manner as in step 1005, and FW inspector 250 inspects a firewall in the same manner as in step 1006. If the inspected firewall is determined as allowing the attacking packet to pass, FW inspector 250 adds the attack title of the packet to the rule which has led to the determined result that the packet is allowed to pass, among the rules included in the non-unique policy stored in non-unique policy memory 225.

After the inspection, policy converter 155 identifies the type and version of the firewall from the information added to the non-unique policy for identifying the unique policy, and reads the policy conversion rule that depends on the type and version of the firewall. Then, policy converter 155 converts the non-unique policy stored in non-unique policy memory 225 into a unique policy. If the attack title is added to the rule included in the non-unique policy, then the attack title is left as it is.

Communication unit 210 of inspecting system 200 transmits the unique policy converted from the non-unique policy as an inspected result to client system 100. If the attack title has been added to the non-unique policy at the time of the inspection, then the attack title is also added to the unique policy transmitted as the inspected result.

When communication unit 140 of client system 100 receives the inspected result from inspecting system 200, communication unit 140 controls result output unit 160 to output the inspected result.

In the present modification, policy conversion rule memory 125, unique policy memory 135, and non-unique policy memory 225 are implemented by the memory (not shown) which inspecting system 200 has, for example. Policy converter 155 may be implemented by a CPU that operates according to a program, for example.

In the present modification, a policy extracting means corresponds to policy extractor 110. A converting means and an inverse converting means collectively correspond to policy converter 155. An inspection knowledge memory means corresponds to inspection knowledge DB 260. An inspection knowledge memory means corresponds to inspection knowledge DB 260. A determining process executing means corresponds to the CPU (not shown) of inspecting system 200. A virtual firewall generating means corresponds to virtual FW generator 230. An inspecting means and an inspected result generating means collectively corresponds to FW inspector 250. A result output means corresponds to result output unit 160. A policy receiving means and an inspected result transmitting means collectively correspond to communication unit 210 of inspecting system 200.

The present modification offers the same advantages as those of the first embodiment except that the unique policy and the information about the type and version of firewall 300 become known to the service providing corporation.

Inspecting system 200 may be coupled to client system 100 and installed in client corporation network 10. With such a configuration, in order to prevent the client corporation from knowing the operation of inspecting system 200, various data may be encrypted and stored in policy memory 220, virtual FW memory 240, and inspection knowledge DB 260. When the data stored in policy memory 220, virtual FW memory 240, and inspection knowledge DB 260 are used, they are decrypted and processed. If inspection knowledge is to be added to inspection knowledge DB 260, then the inspection knowledge is added in such a manner that it will not become known to the client corporation. For example, a terminal device (not shown) of the service providing corporation transmits encrypted inspection knowledge to inspecting system 200. When communication unit 210 of inspecting system 200 receives the encrypted inspection knowledge, it adds the encrypted inspection knowledge to inspection knowledge DB 260.

### 2nd Embodiment

FIG. 6 is a block diagram showing an example of the configuration of client system (firewall information extracting system) 100 and inspecting system 200 according to the present embodiment. Those components and units shown in FIG. 6 which are identical to those shown in FIG. 2 are denoted by identical reference characters, and will not be described in detail below.

Inspecting system 200 has inspection correction knowledge DB 280 instead of inspection knowledge DB 260 shown in FIG. 2 and FW inspection corrector 270 instead of FW inspector 250 shown in FIG. 2.

Inspection correction knowledge DB 280 stores inspection correaction knowledge therein. Inspection correction knowledge refers to data comprising inspection knowledge to which there is added correction guideline information for a rule that allows an inspection packet to pass. On the correction guideline information is described in the same format as rules of a non-unique policy, and has a certain element that is not specified. On the correction guideline information is described such that an element of a rule which allows an inspection packet to pass is applied to the element that is not specified, the rule is changed to a rule which does not allow the inspection packet to pass. Inspection correction knowledge DB 280 may be implemented by the memory which inspecting system 200 has.

FW inspection corrector 270 performs the same processing sequence as FW inspector 250 shown in FIG. 2. FW inspection corrector 270 also generates a rule which does not allow an inspection packet to pass, using a rule that is determined as allowing the inspection packet to pass, and on the correction guideline information. FW inspection corrector 270 corrects a non-unique policy by adding the generated rule thereto. FW inspection corrector 270 may be implemented by a CPU that operates according to a program, for example.

Client system 100 has policy applier 170 instead of policy inverse converter 150 shown in FIG. 2. Policy applier 170 converts a corrected result (in the present embodiment, a non-unique policy inspected and corrected by FW inspection corrector 270) into a unique policy, and outputs the unique policy to result output unit 160. This process of policy applier 170 is the same as the processing sequence performed by policy inverse converter 150 shown in FIG. 2. Policy applier 170 also applies the unique policy converted from the corrected result to firewall 300.

According to the present embodiment, communication unit 140 stores the corrected result received from inspecting system 200 in policy memory 130. After policy applier 170 has applied the unique policy to firewall 300, if the operator enters an instruction to reapply the firewall policy, policy applier 170 reads the corrected result from policy memory 130, and again performs the process of converting the corrected result into a unique policy and the process of applying the unique policy to firewall 300. The instruction to reapply the firewall policy is entered through an input device (not shown) such as a keyboard, a mouse, or the like which client system 100 has, for example.

The conversion of the corrected result into the unique policy and the application of the unique policy to firewall 300 have been described herein. However, when an instruction to reapply the firewall policy is entered, policy applier 170 may convert a non-unique policy (a non-unique policy prior to being corrected) converted from the unique policy into the setting information by policy extractor 110, into a unique policy, and may reapply the unique policy to firewall 300. In this case, communication unit 140 may, not store the corrected result received from inspection system 200 in policy memory 130.

Policy applier 170 may be implemented by a CPU that operates according to a program, for example.

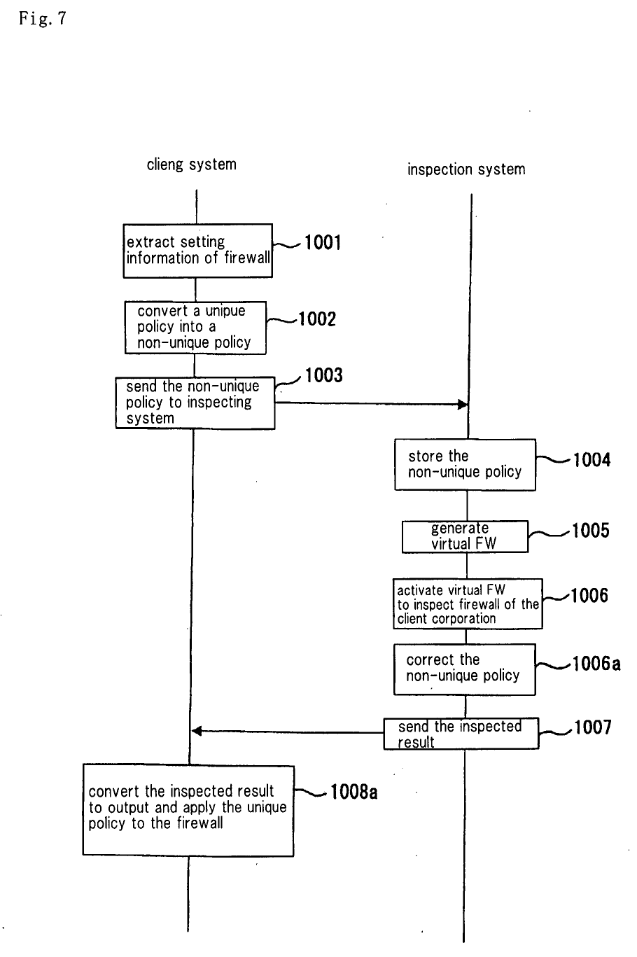

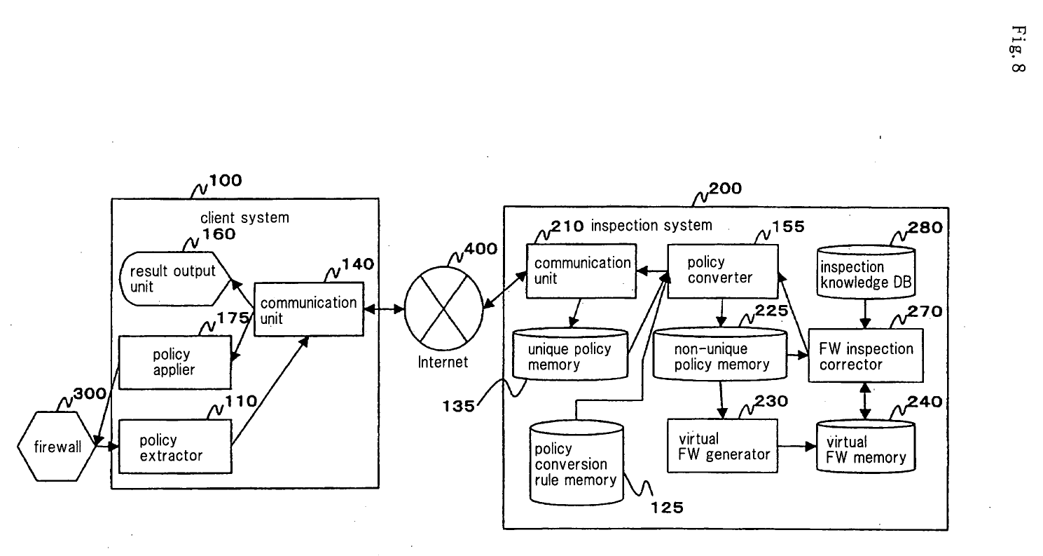

Operation of the present embodiment will be described below. FIG. 7 is a flowchart showing an operation sequence of the firewall inspecting system according to the present embodiment. Those processing details shown in FIG. 7 which are identical to those shown in FIG. 4 are denoted by identical reference characters, and will not be described in detail herein.

After step 1006 is finished, the non-unique policy stored in policy memory 220 of inspecting system 200 represents the rule which has been determined as allowing the attack packet to pass, with the attack title added thereto. FW inspection corrector 270 corrects the non-unique policy representing the rule with the attack title added thereto (step 1006a). In step 1006a, FW inspection corrector 270 removes the rule with the attack title added thereto (the rule which has been determined as allowing the inspection packet to pass), from among the rules included in the non-unique policy. Then, FW inspection corrector 270 reads the correction guideline information associated with the attack title from inspection correction knowledge DB 280. FW inspection corrector 270 generates a new rule which will not allow the inspection packet to pass, using the rule with the attack title added thereto and on the correaction guideline information. At this time, FW inspection corrector 270 generates a new rule by applying the element of the rule which has been determined as allowing the inspection packet to pass, to the unspecified element in on the correction guideline information that is described in the same format as the rules of the non-unique policy. FW inspection corrector 270 inserts the newly generated rule in front of the rule with the attack title added thereto, and deletes the added attack title. As a result, it is determined that the inspection packet is blocked, based on the newly generated rule.

Inspection correction knowledge DB 280 may store inspection correction knowledge including information “NONE” as the correction guideline information. The correction guideline information associated with the attack title may be information “NONE”. In this case, a new rule may not be generated from the rule with the attack title added thereto. In other words, there may be a case where a new rule cannot be generated from the rule with the attack title added thereto.

FW inspection corrector 270 transmits the corrected result (the non-unique policy inspected and corrected by FW inspection corrector 270) to communication unit 210 of inspecting system 200. Communication unit 210 transmits the corrected result through Internet 400 to client system 100 (step 1007). This operation is the same as the operation in step 1007 according to the first embodiment.

Communication unit 140 of client system 100 receives the corrected result from communication unit 210 of inspecting system 200, and transfers the corrected result to policy applier 170. Communication unit 140 also stores the received corrected result in policy memory 130. Policy applier 170 may read the corrected result from policy memory 130. As with policy inverse converter 150 shown in FIG. 2, policy applier 170 reads the policy conversion rule from policy conversion rule memory 120. Policy applier 170 converts the non-unique policy included in the corrected result into a unique policy in a format that depends on firewall 300, by referring to the policy conversion rule. Policy applier 170 controls result output unit 160 to output (e.g., display) the unique policy (step 1008a).

If the information of the attack title added in step 1006 is included in the corrected result, then the information of the attack title is also output. In step 1008a, policy applier 170 applies the unique policy converted from the non-unique policy to firewall 300. Since the non-unique policy has been corrected in step 1006a, the unique policy converted from the non-unique policy is different from the original unique policy. When the converted unique policy is applied to firewall 300, the firewall policy of firewall 300 is changed. Specifically, the firewall policy of firewall 300 is changed so as not to allow attacking packets to pass.

After the client corporation which has installed client system 100 has received inspection services even once, policy memory 130 of client system 100 stores a corrected non-unique policy. Therefore, even if the client corporation does not receive inspection services again from inspecting system 200, the firewall policy of firewall 300 owned by the client corporation can be restored (reapplied) based on the non-unique policy stored in policy memory 300. The firewall policy is restored when the firewall policy has been corrupted for some reason or when the type of firewall 300 is changed, for example. When an instruction to reapply the firewall policy is entered from the input device (not shown), policy applier 170 reads the policy conversion rule, converts the non-unique policy into the unique policy, and reapplies the unique policy to firewall 300, in the same manner as in step 1008a.

If the type of firewall 300 is changed, then the non-unique policy needs to be converted into a unique policy using a policy conversion rule that is different from the policy conversion rule which has been previously referred to. When the firewall policy is to be reapplied, policy applier 170 is therefore supplied with the instruction to reapply the firewall policy and also the information about the type and version of firewall 300, through the input device (not shown). Policy applier 170 may read the policy conversion rule that depends on the input information about the type and version of firewall 300, and convert the non-unique policy into a unique policy using the policy conversion rule. If the type of firewall 300 is not changed, then policy applier 170 does not need to be supplied with the information about the type and version of firewall 300. In this case, policy applier 170 may specify the policy conversion rule in the same manner as does policy inverse converter 150 shown in FIG. 2. Specifically, since the number corresponding to the type and version of the firewall is added in advance to the non-unique policy in step 1003, policy applier 170 may identify the type and version of the firewall from the number added to the non-unique policy in the corrected result, and may further identify the policy conversion rule.

Policy applier 170 may convert a non-unique policy (a non-unique policy prior to being corrected) stored in policy memory 130 by policy extractor 110, into a unique policy, and may apply the unique policy to firewall 300. When policy applier 170 is supplied with an instruction to reapply the firewall policy and the information about the type and version of firewall 300 through the input device (not shown), policy applier 170 reads the policy conversion rule that depends on the information about the type and version of firewall 300. Policy applier 170 converts the non-unique policy that has been stored in policy memory 130 in step 1002, into a unique policy, and applies the unique policy to firewall 300. In this case, communication unit 140 of client system 100 may not store the corrected result received from inspecting system 200 in policy memory 130.

In the present embodiment, a policy extracting means and a converting means collectively correspond to policy extractor 110. An inspection correction knowledge memory means corresponds to inspection correction knowledge DB 280. A determining process executing means corresponds to the CPU (not shown) of inspecting system 200. A virtual firewall generating means corresponds to virtual FW generator 230. An inspecting means, an inspected result generating means, and a correcting means collectively correspond to FW inspection corrector 270. An inverse converting means corresponds to policy inverse converter 150. A result output means corresponds to result output unit 160. A policy applying means corresponds to policy applier 170. A non-unique policy memory means corresponds to policy memory 130 of client system 100. An instruction input means corresponds to the input device (not shown) which client system 100 has. A non-unique policy transmitting means and a corrected result receiving means collectively correspond to communication unit 140 of client system 100. A non-unique policy receiving means and a corrected result transmitting means collectively correspond to communication unit 210 of inspecting system 200.

The present embodiment offers the same advantages as those of the first embodiment, and additionally offers the following advantages:

In the present embodiment, inspecting system 200 receives a non-unique policy from client system 100. After a virtual FW has been inspected, FW inspection corrector 270 generates a new rule that will not allow an inspection packet to pass, using the rule which has been determined as allowing the inspection packet to pass, and on the correction guideline information. Then, inspecting system 200 transmits the non-unique policy with the new rule added thereto to client system 100. Policy applier 170 of client system 100 converts the non-unique policy into a unique policy and applies the unique polity to firewall 300. Therefore, even if the firewall is in a state that allows more packets than necessary to pass, the service providing corporation can provide a specific countermeasure for improving the state of the firewall to the client corporation.

When an instruction to reapply the firewall policy is entered, (policy applier 170 converts the non-unique policy stored in policy memory 130 into a unique policy and applies the unique polity to firewall 300. Therefore, the client corporation can easily restore the firewall policy when the firewall policy has been corrupted for some reason or when the type of firewall 300 is changed. Since the firewall policy can easily be restored even when the type of firewall 300 is changed, the client corporation can freely change firewall devices and firewall software.

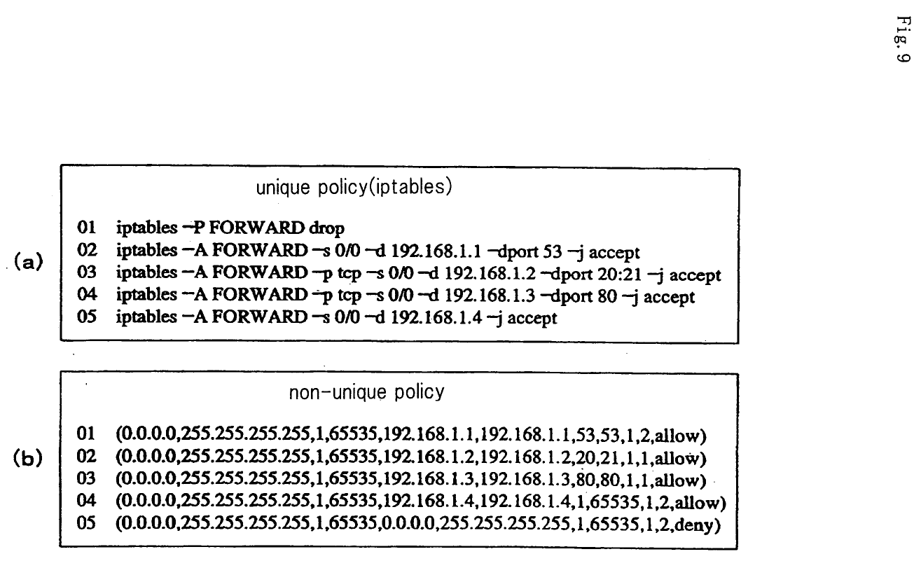

As described in the first embodiment, if the client corporation provides for disclosing the firewall policy and the type and version of firewall 300, then the client corporation may transmit the disclosed information to inspecting system 200, and inspecting system 200 may convert the unique policy into a non-unique policy. FIG. 8 shows a modification of the present embodiment in which a unique policy in a format that depends on the type of the firewall and the information about the type and version of the firewall are transmitted to inspecting system 200.

In the example of configuration shown in FIG. 8, communication unit 210, policy conversion rule memory 125, unique policy memory 135, policy converter 155, and non-unique policy memory 225 of inspecting system 200 are identical respectively to communication unit 210, policy conversion rule memory 125, unique policy memory 135, policy converter 155, and non-unique policy memory 225 shown in FIG. 5 (the modification of the first embodiment). Virtual FW generator 230, virtual FW memory 240, FW inspection corrector 270, and inspection correction knowledge DB 280 of inspecting system 200 are identical respectively to virtual FW generator 230, virtual FW memory 240, FW inspection corrector 270, and inspection correction knowledge DB 280 shown in FIG. 6 (the second embodiment).

Policy extractor 110, communication unit 140, and result output unit 160 of client system 100 are identical respectively to policy extractor 110, communication unit 140, and result output unit 160 shown in FIG. 5 (the modification of the first embodiment). Policy applier 175 of client system 100 is identical to policy applier 170 shown in FIG. 6, but does not convert a non-unique policy into a unique policy. When a non-unique policy corrected by FW inspection corrector 270 is converted into a unique policy by policy converter 155 and the unique policy is received by client system 100, policy applier 175 sets the unique policy in firewall 300.

The firewall inspecting system shown in FIG. 8 operates as follows: Policy extractor 110 extracts setting information from firewall 300, and transmits a firewall policy (unique policy) and the information about the type and version of firewall 300, which are included in the setting information, to communication unit 140. Communication unit 140 transmits the unique policy and the information about the type and version of firewall 300 to inspecting system 200.

Communication unit 210 of inspecting system 200 stores the unique policy and the information about the type and version of firewall 300, which have been received from client system 100, in unique policy memory 135. Communication unit 210 may also store the time at which the unique policy was received in unique policy memory 135. Communication unit 210 may associate a number or the like for identifying each unique policy with the unique policy and store them in unique policy memory 135.

After the unique policy has been stored in unique policy memory 135 by communication unit 210, policy converter 155 reads a policy conversion rule that depends on the type and version of the firewall stored together with the unique policy, from policy conversion rule memory 125. Based on the policy conversion rule, policy converter 155 converts the unique policy stored in unique policy memory 135 into a non-unique policy, and stores the non-unique policy in non-unique policy memory 225. The information (the number or the like) added to identify each unique policy is also added to the converted non-unique policy.

After the non-unique policy has been stored in non-unique policy memory 225, virtual FW generator 230 generates virtual FW 300, and FW inspection corrector 270 inspects a firewall in the same manner as in step 1006. FW inspection corrector 270 corrects the non-unique policy in the same manner as with step 1006a. FW inspection corrector 270 stores the corrected result in non-unique policy memory 225.

After the non-unique policy has been corrected, policy converter 155 identifies the type and version of the firewall from the information added to the non-unique policy for identifying the unique policy, and reads the policy conversion rule that depends on the type and version of the firewall. Then, policy converter 155 converts the non-unique policy stored in non-unique policy memory 225 into a unique policy. If the attack title is added to the rule included in the non-unique policy, then the attack title is left as it is.

When communication unit 140 in client system 100 receives the inspected result from inspecting system 200, communication unit 140 controls result output unit 160 to output the inspected result. Communication unit 140 transfers the corrected result to policy applier 175, which in turn applies the unique policy included in the corrected result to firewall 300.

When an instruction to reapply the firewall policy is entered from the input device (not shown), communication unit 140 of client system 100 transmits the instruction to inspecting system 200. At this time, information about the type and version of firewall 300 may be entered, and communication unit 140 may transmit the information about the type and version of firewall 300. When communication unit 210 of inspecting system 200 receives an instruction from client system 100, communication unit 210 controls policy converter 155 to convert the corrected non-unique policy into a unique policy, and transmits the unique policy to client system 100. When communication unit 140 of client system 100 receives the unique policy, communication unit 140 transfers the unique policy to policy applier 175, which reapplies the unique policy to firewall 300.

The firewall policy may be reapplied based on the non-unique policy prior to being corrected. In this case, when communication unit 210 in inspecting system 200 receives an instruction to reapply the firewall policy and the information about the type and version of firewall 300, communication unit 210 controls policy converter 155 to read the policy conversion rule that depends on the information about the type and version of firewall 300. Using the policy conversion rule, policy converter 155 converts the non-unique policy prior to being corrected which is stored in non-unique policy memory 225 into a unique policy. Communication unit 210 transmits the unique policy to client system 100. Having received the unique policy, client system 100 resets the unique policy in firewall 300. If the firewall policy is reapplied based on the non-unique policy prior to being corrected, FW inspection corrector 270 may not store the corrected result in non-unique policy memory 225.

In the present modification, a policy extracting means corresponds to policy extractor 110. A converting means and an inverse converting means collectively correspond to policy converter 155. An inspection correction knowledge memory means corresponds to inspection correction knowledge DB 280. A determining process executing means corresponds to the CPU (not shown) of inspecting system 200. A virtual firewall generating means corresponds to virtual FW generator 230. An inspecting means, an inspected result generating means, and a correcting means collectively correspond to FW inspection corrector 270. A result output means corresponds to result output unit 160. A policy applying means corresponds to policy applier 175. A non-unique policy memory means corresponds to non-unique policy memory 225. An instruction input means corresponds to the input device (not shown) which client system 100 has. A policy receiving means and a corrected policy transmitting means collectively correspond to communication unit 210 of inspecting system 200.

The present modification offers the same advantages as those of the second embodiment except that the unique policy and the information about the type and version of firewall 300 become known to the service providing corporation.

Inspecting system 200 may be integrated with client system 100 and installed in client corporation network 10. With such a configuration, in order to prevent the client corporation from knowing the operation of inspecting system 200, various data are encrypted and stored in policy memory 220, virtual FW memory 240, and inspection correction knowledge DB 280. When the data stored in policy memory 220, virtual FW memory 240, and inspection correaction knowledge DB 280 are used, they are decrypted and processed. If inspection correction knowledge is to be added to inspection correction knowledge DB 280, then the inspection correction knowledge is added in such a manner that it will not become known to the client corporation. For example, a terminal device (not shown) of the service providing corporation transmits encrypted inspection correction knowledge to inspecting system 200. When communication unit 210 of inspecting system 200 receives the encrypted inspection correction knowledge, it adds the encrypted inspection correction knowledge to inspection correction knowledge DB 280.

### 1ST SPECIFIC EXAMPLE

A specific example of the first embodiment will be illustrated. In the specific example, the firewall inspecting system having client system 100 and inspecting system 200 shown in FIG. 2 will be described. The service providing corporation which provides inspection services sells client system 100 to the client corporation which receives the inspection services. The client corporation pays the service providing corporation for the inspection services. The client corporation installs client system 100 in a network segment that is capable of accessing firewall 300 in client corporation network 10 (see FIG. 1).

Policy extractor 110 of client system 100 extracts setting information from firewall 300 (step 1001 shown in FIG. 4). For example, policy extractor 110 periodically extracts setting information. Alternatively, policy extractor 110 may extract setting information from firewall 300 when an instruction to extract setting information is entered from the operator of the client corporation. Further alternatively, policy extractor 110 may be previously determined to start a setting information extracting process at a time determined by a contract between the client corporation and the service providing corporation, and may start extracting setting information at the determined time.

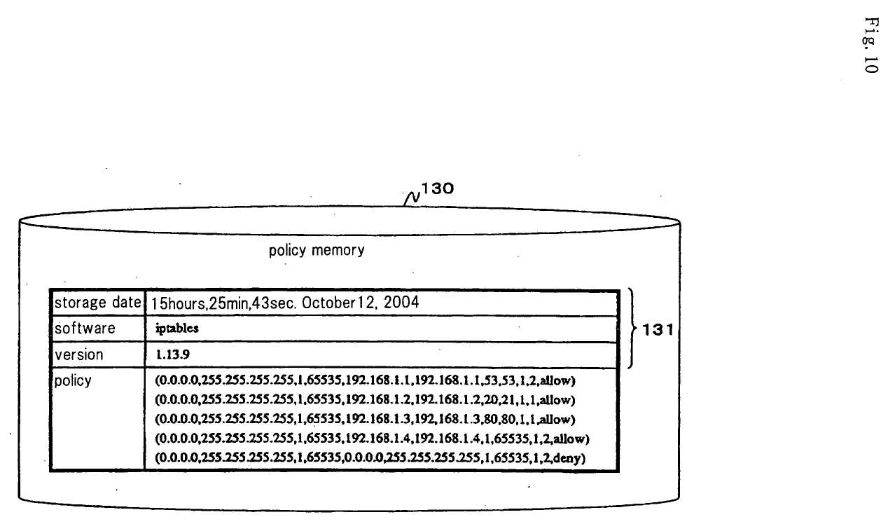

Then, policy extractor 110 converts a unique policy included in the setting information into a non-unique policy (step 1002 shown in FIG. 4). An example of the unique policy is shown in FIG. 9(a), and an example of the non-unique policy converted from the unique policy shown in FIG. 9(a) is shown in FIG. 9(b).

It is assumed in this example that firewall 300 operates according to iptables (software product name). The firewall policy (unique policy) of iptables shown in FIG. 9(a) includes five rules. The rule in the first line (01st line) in FIG. 9(a) is a rule referred to as a default rule. The default rule is a rule for governing the operation of the firewall when a packet to be determined as to whether it is to be allowed to pass or not is not in accordance with rules other than the default rule. The default rule shown in FIG. 9(a) prescribes that all packets shall be blocked (dropped). According to the firewall policy of iptables, “-p” is a symbol indicating a protocol such as tcp, udp, or the like, and an indicated protocol is described following “-p”. If “-p” and a protocol following “-p” are not described, then it means that no particular packet protocol is specified. “-s” is a symbol indicating a source address, and an indicated source address is described following “-s”. “-d” is a symbol indicating a destination address, and an indicated destination address is described following “-d”. “-dport” is a symbol indicating a destination port number, and an indicated destination port number is described following “-dport”. If “-dport” and an indicated destination port number following “-dport” are not described, then it means that no particular destination port number is specified. “-j” is a symbol indicating an action (to allow a packet to pass or to block) on a packet whose protocol, source address, destination address, and destination port number are in agreement with those indicated. If the packet is allowed to pass, then “accept” is described next to “-j”. If the packet is blocked, then “drop” is described next to “-j”. The rule in the 02nd line in FIG. 9(a) is a rule for allowing a packet to pass whose protocol is not specified, source address is 0/0, i.e., an arbitrary IP address space, destination address is 192.168.1.1, and destination port number is “53 (a port number to which a name resolving service is assigned)”. The rules in the 03rd and following lines also prescribe conditions for allowing packets to pass.

Policy extractor 110 reads the policy conversion rule corresponding to the information about the type and version of firewall 300 from policy conversion rule memory 120. Policy extractor 110 then converts the unique policy shown in FIG. 9(a) into the non-unique policy shown in FIG. 9(b), by referring to the policy conversion rule. The information about the type and version of firewall 300 is included in the setting information, for example.

In the present specific example, it is assumed that the default rule is described in the final line of the non-unique policy. Therefore, the default rule in the 01th line in FIG. 9(a) is described in the final line (05th line) of the non-unique policy shown in FIG. 9(b). The rules included in the non-unique policy are described in a format (SA1, SA2, SP1, SP2, DA1, DA2, DP1, DP2, P1, P2, A). In this format, “SA1” represents a start source address, and “SA2” an end source address. “SP1” represents a start source port number, and “SP2” an end source port number. “DA1” represents a start destination address, and “DA2” an end destination address. “DP” represents a start destination port number, and “DP2” an end destination port number. “P1” represents a start protocol number, and “P2” an end protocol number. It is assumed that a protocol number “1” represents TCP, and a protocol number “2” UDP. Therefore, if P1 is “1” and P2 is “2”, they indicate protocols TCP, UDP. “A” represents an action on a packet, with either “allow” (to be passed) or “deny” (to be blocked) being described in “A”. According to the rules shown in FIG. 9(a), since no source port number is specified, SP1 is set to “1” and SP2 to “65535” according to the non-unique policy, indicating all values that can be taken by the source port number.

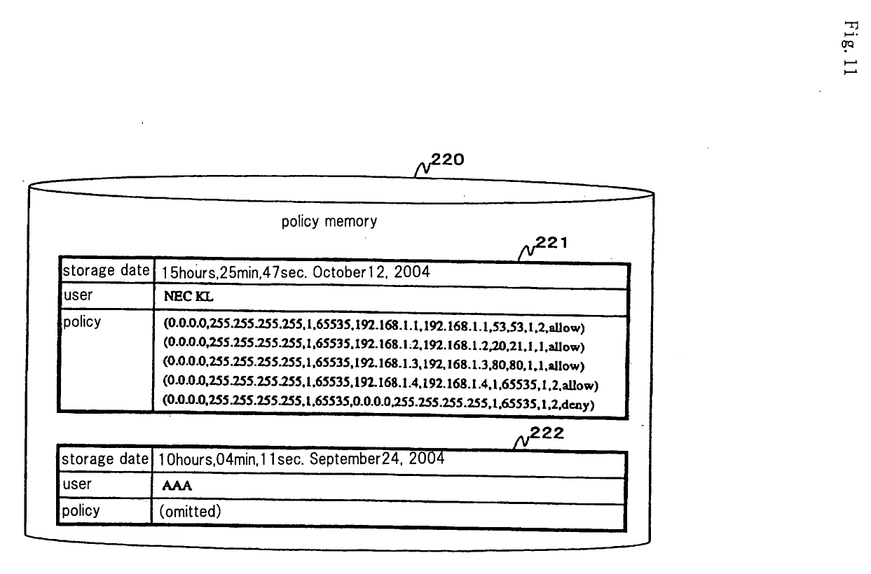

Policy extractor 110 stores the non-unique policy converted from the unique policy in policy memory 130. FIG. 10 is a diagram showing an example of information stored in policy memory 130 of client system 100. As shown in FIG. 10, policy extractor 110 stores, together with the non-unique policy, the time and data at which the non-unique policy has been stored, and the type and version of the firewall, as ancillary information 131, in policy memory 131. In the example shown in FIG. 10, as the type of the firewall, a software type, specifically, the product name “iptables” is stored. Information “1.13.9” is stored as the version of the firewall.

Communication unit 140 of client system 100 reads the non-unique policy from policy memory 130 and transmits the non-unique policy to inspecting system 200 (step 1003 shown in FIG. 4). Communication unit 140 transmits the non-unique policy from among non-unique policy and ancillary information 131 stored in policy memory 131. Communication unit 140 does not transmit ancillary information 131 itself, but adds a number, which becomes a serial number each time communication unit 140 transmits a non-unique policy, to the non-unique policy, and transmits the number and the non-unique policy. Communication unit 140 associates the number with the information about the type and version of firewall 300, and stores them in policy memory 130, for example. Communication unit 140 also transmits an ID for identifying the client corporation (hereinafter referred to as user ID), together with the non-unique policy. The user ID may be entered in advance from the operator through the input device (not shown) such as a keyboard or the like, and stored in the memory (not shown) of client system 100.

Communication unit 210 of inspecting system 200 receives the non-unique policy and the user ID from client system 100, and stores the non-unique policy and the user ID that are received in policy memory 220 (step 1004 shown in FIG. 4). FIG. 11 is a diagram showing an example of information stored in policy memory 220 of inspecting system 200. In the example shown in FIG. 11, policy memory 220 stores the user ID “NEC KL”, the non-unique policy, and information representing the time and date at which the non-unique policy is stored, as data 221. Similarly, policy memory 220 stores information received from the client corporation whose user ID is “AAA”, as data 222.

Then, virtual FW generator 230 of inspecting system 200 generates a virtual FW using the non-unique policy stored in policy memory 220, and stores the virtual FW in virtual FW memory 240 (step 1005 shown in FIG. 4). Virtual FW generator 230 generates one virtual FW for one non-unique policy. If there are a plurality of non-unique policies, i.e., if a plurality of client corporations and respective non-unique policies received from the client corporations are stored in policy memory 220, then virtual FW generator 230 generates virtual FWs with respect to the respective non-unique policies. A virtual FW is generated by adding non-unique policy 510 (see FIG. 3) to FW execution instruction 520 (see FIG. 3). The part of FW execution instruction 520 is common in the virtual FWs. Since there are a plurality of client corporations to which the service providing corporation provides inspection services, the virtual FWs are managed using user IDs, etc. so that the non-unique policy of a certain client corporation will not leak to another client corporation. Details of an operation sequence for inspecting firewalls of the respective client corporations will be described later.

FW inspector 250 activates virtual FW 500 (see FIG. 3) to inspect firewall 300 of the client corporation (step 1006 shown in FIG. 4).

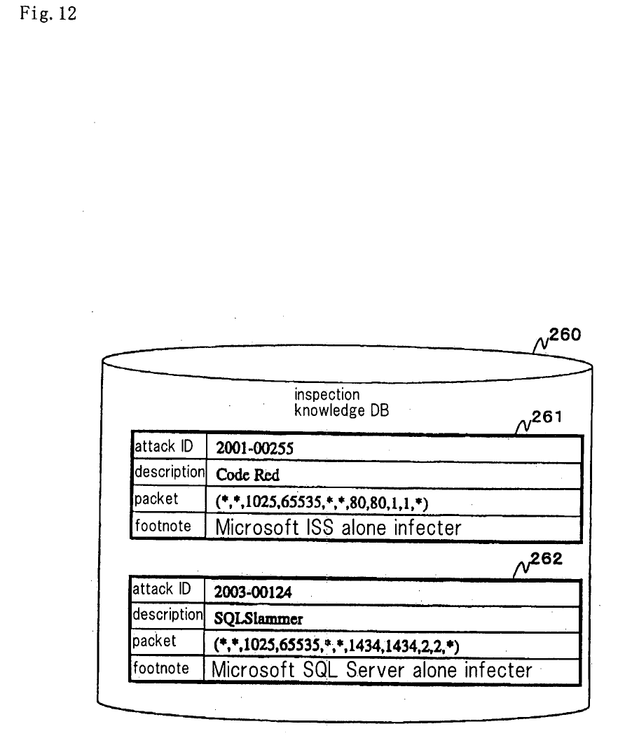

Prior to the description of an inspecting process, an example of inspection knowledge stored in inspection knowledge DB 260 will be described below. FIG. 12 is a diagram showing an example of inspection knowledge stored in inspection knowledge DB 260. Each of inspection knowledge 261, 262 shown in FIG. 12 includes the information: “Attack ID”, “Description”, “Packet”, and “Footnote”. “Attack ID” is an ID for uniquely identifying the inspection knowledge. “Description” represents the title of the attack. “Packet” represents an inspection packet. “Footnote” represents supplemental matter indicative of a device which will be infected by an attack. The inspection knowledge may not include “Attack ID” and “Footnote”. The essence of the inspection knowledge is data representing an attack itself or data representing an attribute of an attack (i.e., an inspection packet).

The packet (inspection packet) included in inspection knowledge is described in substantially the same format as the rules included in non-unique policies, i.e., in a format (SA1, SA2, SP1, SP2, DA1, DA2, DP1, DP2, P1, P2, C). The elements of the format, except the final “C”, are the same as those elements of the rules included in non-unique policies. “C” corresponds to the payload (data) of an inspection packet, and specifically represents an attack code. “*” indicative of “arbitrary” may be described as “C”. Alternatively, an attack code may be described as “C”. In the example shown in FIG. 12, “*”, rather than an attack code, is described as “C”, indicating that no attack code is specified. In the example shown in FIG. 12, “*” indicative of “arbitrary” is also described as “SA1” (start source address), “SA2” (end source address), “DA1” (start destination address), and “DA2” (end destination address).

The portion of the inspection packet other than “C” represents an attribute of the inspection packet (an attribute of the attack).

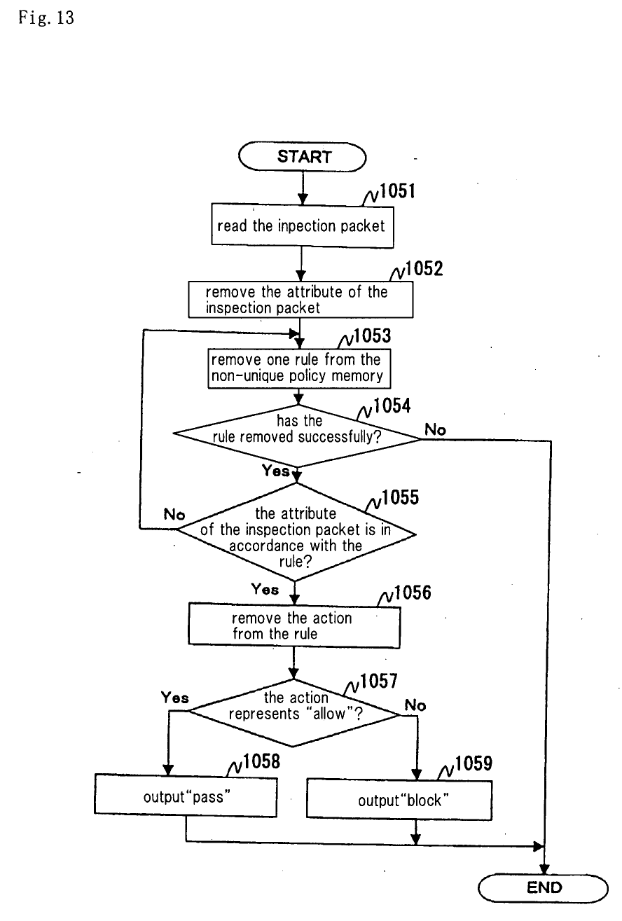

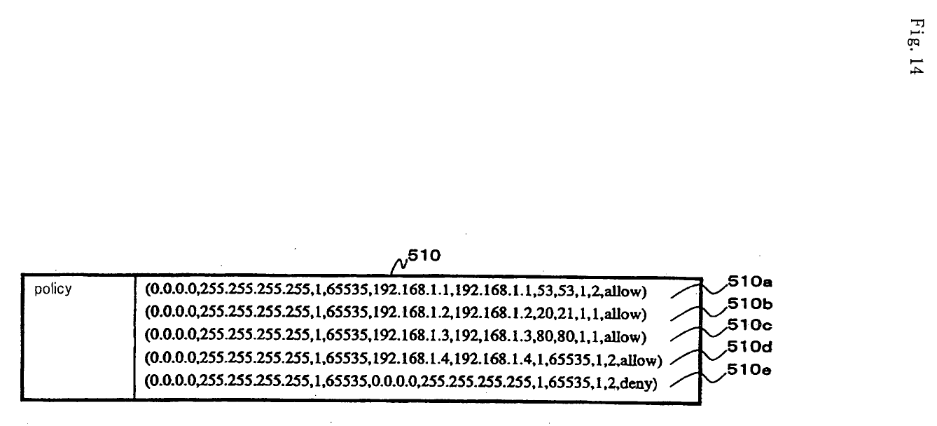

FIG. 13 is a flowchart of a process of determining whether a packet is allowed to pass or not, performed by the CPU (not shown) of inspecting system 200 which operates according to virtual FW 500. FW inspector 250 reads an inspection packet from inspection knowledge DB 260, and transfers the inspection packet to the CPU (not shown) operating according to virtual FW 500. The CPU receives the inspection packet (step 1051). For example, FW inspector 250 writes the inspection packet in RAM (not shown), and the CPU reads the inspection packet.

Then, the CPU removes the attribute of the inspection packet (the portion of the packet other than the payload “C”) (step 1052). Specifically, the CPU removes the portion of the inspection packet which represents the range of source addresses, the range of source port numbers, the range of destination addresses, the range of destination port numbers, and the range of protocols. Then, the CPU removes one rule from non-unique policy 510 (see FIG. 3) included in virtual FW 500 (step 1053). The CPU removes one rule each time control goes to step 1053. The CPU removes rules in a sequence from the first one in virtual FW 500. Therefore, when control goes to step 1053 for the first time, the CPU removes the first rule. After step 1053, the CPU determines whether it has removed the rule successfully or not (step 1054). If the CPU has failed (the CPU has not removed the rule), then the process of determining whether a packet is allowed to pass or not is brought to an end.

If the CPU has removed the rule successfully, then the CPU determines whether the attribute of the inspection packet that has been removed in step 1052 is in accordance with the rule that has been removed in step 1053 or not (step 1055). If the attribute of the inspection packet is in accordance with the rule, then control goes back to step 1053, and the CPU repeats the processing operation from step 1053. If the attribute of the inspection packet is in accordance with the rule, then the CPU removes the action (represented by the final element “A” of the rule in the non-unique policy) from the rule (step 1056). Then, the CPU determines whether the action represents “allow” or “not allow” (step 1057). If the action represents “allow”, then the CPU transfers the result indicating that the inspection packet is allowed to pass according to the rule that has been removed and the rule which has led to the result (the rule in accordance with the attribute of the inspection packet), to FW inspector 250 (step 1058). If the action represents “deny”, then the CPU transfers the result indicating that the inspection packet has been blocked according to the rule that has been removed and the rule which has led to the result, to FW inspector 250 (step 1059). After step 1058 or step 1059 has been executed, the process of determining whether a packet is allowed to pass or not is brought to an end.

FW inspector 250 successively removes inspection knowledge from inspection knowledge DB 260, and transfers an inspection packet included in each of the inspection knowledge to the CPU which operates according to virtual FW 500. Then, FW inspector 250 receives the result indicating that the inspection packet is allowed to pass or the result indicating that the inspection packet is blocked, and the rule which has led to the result, from the CPU which operates according to virtual FW 500. If FW inspector 250 receives the result indicating that the inspection packet is allowed to pass and the rule which has led to the result, then FW inspector 250 adds the title of the attack (e.g., “Code Red” shown in FIG. 12) that corresponds to the inspection packet to the rule in the non-unique policy stored in policy memory 220.

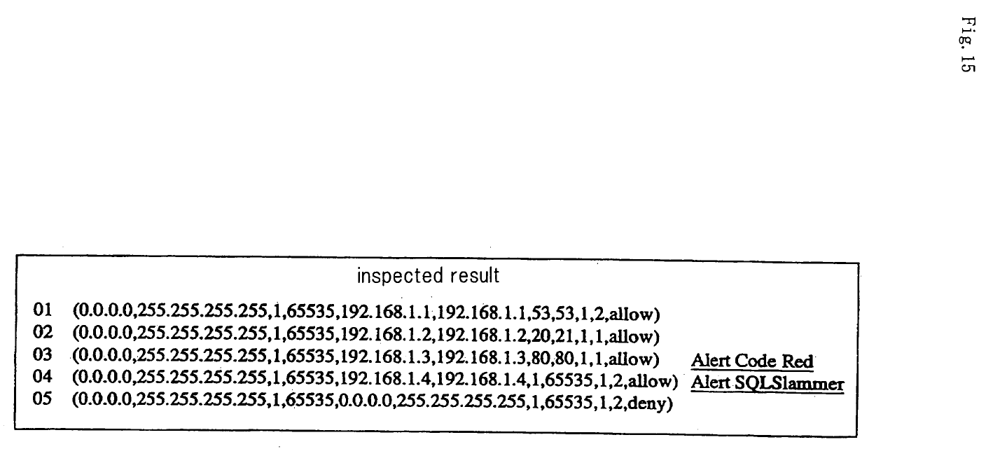

A specific example of a process up to the generation of an inspected result by adding an attack title to a non-unique policy will be described below. It is assumed that non-unique policy 510 shown in FIG. 14 is included in virtual FW 500 generated in step 1005. Non-unique policy 510 shown in FIG. 14 includes five rules 510a through 510e.

FW inspector 250 successively removes inspection knowledge from inspection knowledge DB 260. Herein, it is assumed that FW inspector 250 first removes inspection knowledge 261 (see FIG. 12) whose attack ID is “2001-00255”. FW inspector 250 transfers the inspection packet included in inspection knowledge 261 to the CPU which operates according to virtual FW 500. The CPU reads the inspection packet (step 1051) and removes the attribute of the inspection packet (step 1052). Specifically, the CPU removes, as the attribute of the inspection packet, the range of source addresses (SA1 and SA2), the range of source port numbers (SP1 and SP2), the range of destination addresses (DA1 and DA2), the range of destination port numbers (DP1 and DP2), and the range of protocols (P1 and P2).

Then, the CPU removes one rule from non-unique policy 510 included in the virtual FW (step 1053). When control goes to step 1053 for the first time, the CPU removes first rule 510a (see FIG. 14). In next step 1054, the CPU determines whether it has removed the rule successfully. Then, the CPU determines whether or not the attribute of the inspection packet is in accordance with rule 510a that has been removed (step 1055). In step 1055, the CPU determines whether or not the attribute of the inspection packet is in accordance with rule 510a by determining whether or not the attribute of the inspection packet falls in the range of source addresses (SA1 and SA2), the range of source port numbers (SP1 and SP2), the range of destination addresses (DA1 and DA2), the range of destination port numbers (DP1 and DP2), and the range of protocols (P1 and P2) as the attribute of the rule. If the attribute of the inspection packet falls in each of the ranges as the attribute of the rule, then the CPU judges that the attribute of the inspection packet is in accordance with rule 510a. If the attribute of the inspection packet does not fall in each of the ranges as the attribute of the rule, then the CPU judges that the attribute of the inspection packet is not in accordance with rule 510a. The CPU judges that the attribute is described as “*” falls in an arbitrary range. A comparison between the attribute of the inspection packet of inspection knowledge 261 (see FIG. 12) and the attribute of rule 510a (see FIG. 14) indicates that the range of source addresses, the range of source port numbers, and the range of destination addresses in the inspection packet fall in the ranges described in rule 510a. The protocol designated by the inspection packet is “1 (indicative of TCP)”, and the protocols designated by rule 510a are “1” and “2 (indicative of UDP)”. The protocol also falls in the range described in rule 510a. However, the range of destination port numbers designated by the inspection packet is “80-80”, whereas the range of destination port numbers designated by rule 510a is “53-53”. Therefore, the range of destination port numbers designated by the inspection packet does not fall in the range of destination port numbers designated by rule 510a. Consequently, the CPU judges that the inspection packet of inspection knowledge 261 is not in accordance with rule 510a, and control goes back to step 1053. Each time control goes back to step 1053, the CPU removes a rule in sequence, and the CPU repeats the processing operation from step 1053.

In the present example, when the CPU removes third rule 510c shown in FIG. 14 in step 1053, the CPU judges that the inspection packet of inspection knowledge 261 is in accordance with rule 510c. Then, control goes to step 1056 in which the CPU removes the action of rule 510c. Since the action of rule 510c represents “allow” (see FIG. 14), the CPU judges “Yes” in the decision process in step 1057, after which control goes to step 1058. That is, the CPU transfers information indicating that the inspection packet transferred from FW inspector 250 is allowed to pass according to rule 510c, to FW inspector 250.

Similarly, when the CPU operating according to the virtual FW is given the inspection packet of inspection knowledge 262 (see FIG. 12) from FW inspector 250, the CPU operating according to the virtual FW transfers information indicating that the inspection packet is allowed to pass according to rule 540d (see FIG. 14), to FW inspector 250.

The attributes of the inspection packets of the inspection knowledge in inspection knowledge DB 260 are by necessity in accordance with the default rule (the final rule in the non-unique policy, i.e., rule 510e in the example shown in FIG. 14). Therefore, a result representing that a packet is either allowed to pass or blocked is obtained with respect to all the inspection packets transferred from FW inspector 250. In the flowchart shown in FIG. 13, if “No” is determined in step 1054, then the process is brought to an end without outputting a result representing that a packet is either allowed to pass or blocked. This occurs in the event of an inspection failure (abnormal condition) wherein no rule is included in non-unique policy 510.

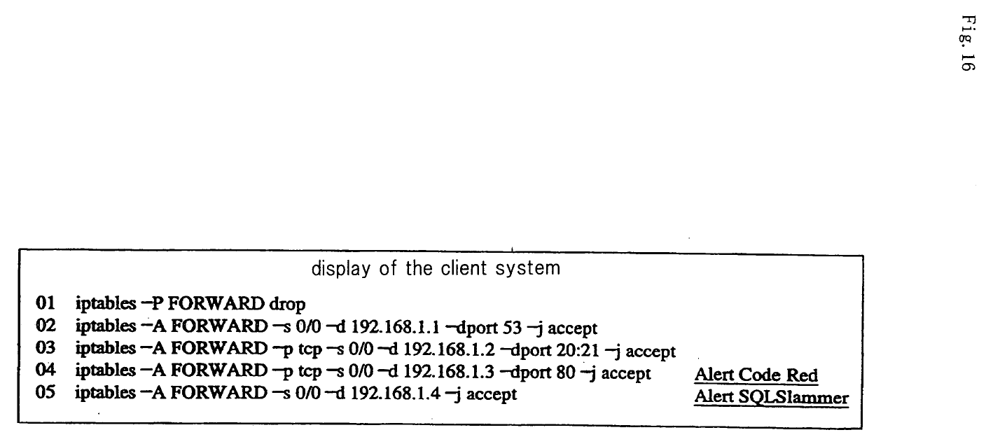

When FW inspector 250 obtains information about the result representing that a packet is either allowed to pass or blocked and the rule that has led to the result, FW inspector 250 reads a non-unique policy from policy memory 220. Then, FW inspector 250 adds the title of the attack on the inspection packet to the rule that has led to the result representing that the inspection packet is allowed to pass, among the rules included in the non-unique policy. In the present example, the non-unique policy with the title of the attack added thereto makes up an inspected result. An example of an inspected result is shown in FIG. 15. As already shown above, the third rule allows the inspection packet of inspection knowledge 261 to pass (see FIG. 12), and the fourth rule allows the inspection packet of inspection knowledge 262 to pass. Therefore, as shown in FIG. 15, FW inspector 15 adds the attack title “Code Red” included in inspection knowledge 261 to the third rule. Likewise, FW inspector 15 adds the attack title “SQL Slammer” included in inspection knowledge 262 to the fourth rule. In the example shown in FIG. 15, the attack titles together with a character string “Alert” are added. As a consequence, the inspected result shown in FIG. 15 indicates that the third rule may possibly allow the attack (Code Red) of inspection knowledge 261 to pass and the fourth rule may possibly allow the attack (SQL Slammer) of inspection knowledge 262 to pass.

FW inspector 250 transmits the inspected result to communication unit 210 of inspecting system 200. Communication unit 210 transmits the inspected result that has been transmitted from FW inspector 250 to client system 100 (step 1007 shown in FIG. 4).

Communication unit 140 of client system 100 receives the inspected result transmitted from inspecting system 200, and transmits the inspected result to policy inverse converter 150. In the above description, communication unit 140 directly transmits the inspected result to policy inverse converter 150. However, communication unit 140 may store the inspected result in policy memory 130, and policy inverse converter 150 may read the inspected result from policy memory 130.

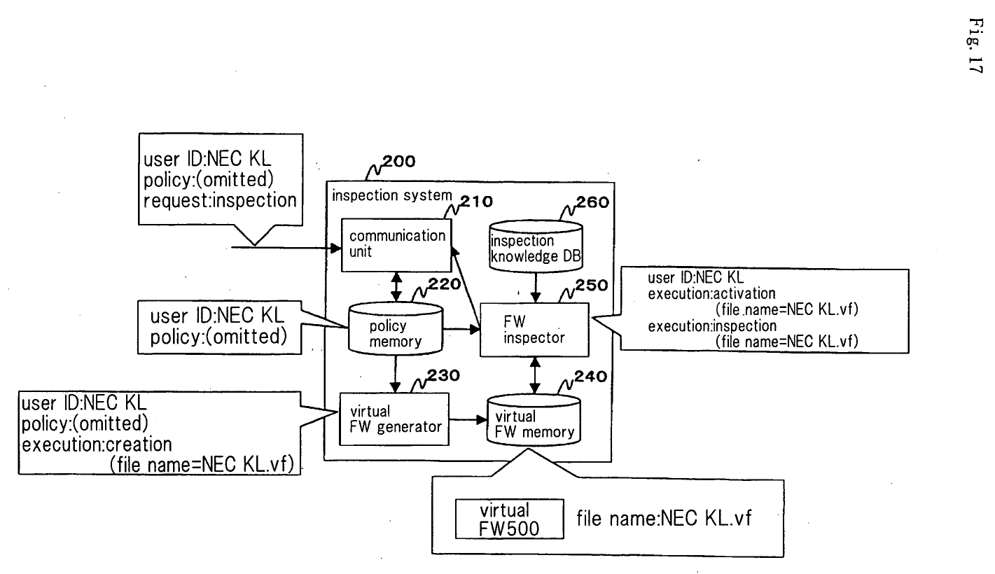

Though not shown in FIG. 15, the number added by communication unit 140 of client system 100 at the time it transmitted the non-unique policy (step 1003) remains added to the inspected result. Based on the number, policy inverse converter 150 identifies the information about the type and version of firewall 300, and reads the policy conversion rule that depends on the number and version from policy conversion rule memory 120. Based on the policy conversion rule policy, inverse converter 150 converts the non-unique policy included in the inspected result received from inspecting system 200 into a unique policy. At this time, the attack titles included in the inspected result are left as they are. As a result, the unique policy with the attack titles added to the rules is obtained as shown in FIG. 16. Policy inverse converter 150 controls result output unit 160 to output (e.g., display) the unique policy with the attack titles added to the rules (step 1008 shown in FIG. 4). As a result, it is possible to present to the client corporation the information indicating which rules allow which attack to pass.

The user of client system 100 of the client corporation corrects the firewall policy of firewall 300 based on the output result.

In the above specific example, policies and inspected results that are exchanged between communication unit 140 of client system 100 and communication unit 210 of inspecting system 200 are transmitted and received as plaintext on Internet 400. However, communication unit 140 of client system 100 may encrypt a non-unique policy and transmit the encrypted non-unique policy, and communication unit 210 of inspecting system 200 may decrypt the received non-unique policy; Similarly, communication unit 210 of inspecting system 200 may encrypt an inspected result, and communication unit 140 of client system 100 may decrypt the received inspected result. Such a configuration can enhance the secrecy of non-unique policies and inspected results that are transmitted and received.

An operation sequence for inspecting each of a plurality of client corporations will be described below. FIG. 17 is a diagram illustrative of a situation where a virtual FW is generated and an inspection is performed for each client corporation. When communication unit 210 of inspecting system 200 receives an inspection request from client system 100, for example, communication unit 210 transmits an answer indicative of the acceptance of the inspection request to client system 100, and thereafter receives a non-unique policy and a user ID (“NEC KL” in this example) from client system 100. The user ID may not be received at the same time as the non-unique policy. For example, when communication unit 210 receives an inspection request, it may authenticate client system 100, receive the user ID at the time of authenticating client system 100, and thereafter receive the non-unique policy.

Communication unit 210 associates the received non-unique policy with the user ID, and stores them in policy memory 220. For example, communication unit 210 stores them like data 221 shown in FIG. 11. Virtual FW generator 230 reads the non-unique policy and the user ID from policy memory 220, and generates virtual FW 500 using the non-unique policy. At this time, virtual FW generator 230 uses the user ID as the file name of virtual FW 500.

For example, virtual FW generator 230 generates virtual FW 500 having a file name “NEC KL.vf”, and stores generated virtual FW 500 in virtual FW memory 240. FW inspector 250 activates and inspects virtual FW 500 having the file name “NEC KL.vf”. As a result, inspection of the firewall of the client corporation having the user ID “NEC KL” is performed. Since virtual FW 500 is generated for each of the user IDs of client corporations, the non-unique policy of a client corporation is prevented from being leaked to the other client corporations. In the above description, virtual FW generator 230 uses the user ID as the file name of virtual FW 500. However, virtual FW generator 230 may not use a user ID as a file name. Rather, virtual FW generator 230 may assign file names capable of identifying respective virtual FWs 500 to virtual FWs 500, and store the file names in association with the user IDs, so that it is possible to recognize which client corporation's virtual FW is referred to by the file of each virtual FW.

### 2ND SPECIFIC EXAMPLE

A specific example of the second embodiment will be illustrated. In the specific example, the firewall inspecting system having client system 100 and inspecting system 200 shown in FIG. 6 will be described. The operation sequence up to the point where FW inspection corrector 270 performs an inspection (steps 1001 through 1006 shown in FIG. 7) is the same as in the first specific example, and will not be described below.

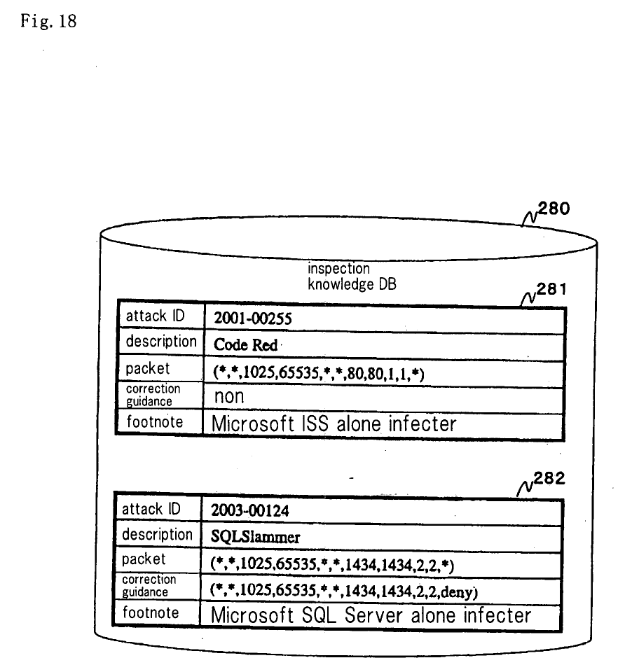

Prior to the description of a process of correcting a non-unique policy with FW inspection corrector 270, an example of inspection knowledge stored in inspection correction knowledge DB 280 will be described below. FIG. 18 is a diagram showing an example of inspection correction knowledge stored in inspection correction knowledge DB 280. Each of inspection correction knowledge 281, 282 shown in FIG. 18 includes information “Attack ID”, “Description”, “Packet”, “Correction guideline”, and “Footnote”. “Attack ID”, “Description”, “Packet”, and “Footnote” represent the same information as the information included in the inspection knowledge (see FIG. 12) indicated in the first specific example. “Correction guideline” represents correction guideline information for rules that allow inspection packets to pass. The inspection correaction knowledge may include information “NONE” as on the correction guideline (see inspection correction knowledge 281 shown in FIG. 18).

On the correction guideline information other than “NONE” is described in the same format as the rules included in the non-unique policy indicated in the first specific example. Specifically, the correction guideline is written in the format (SA1, SA2, SP1, SP2, DA1, DA2, DP1, DP2, P1, P2, A).

The meanings of the elements ranging from SA1 to A have been described above in the first specific example. According to the correction guideline for generating a new rule for blocking an inspection packet from a rule that allow the inspection packet to pass, “deny” is described as “A (action)”. Some elements included in on the correction guideline information are described as “*” and are not specified.

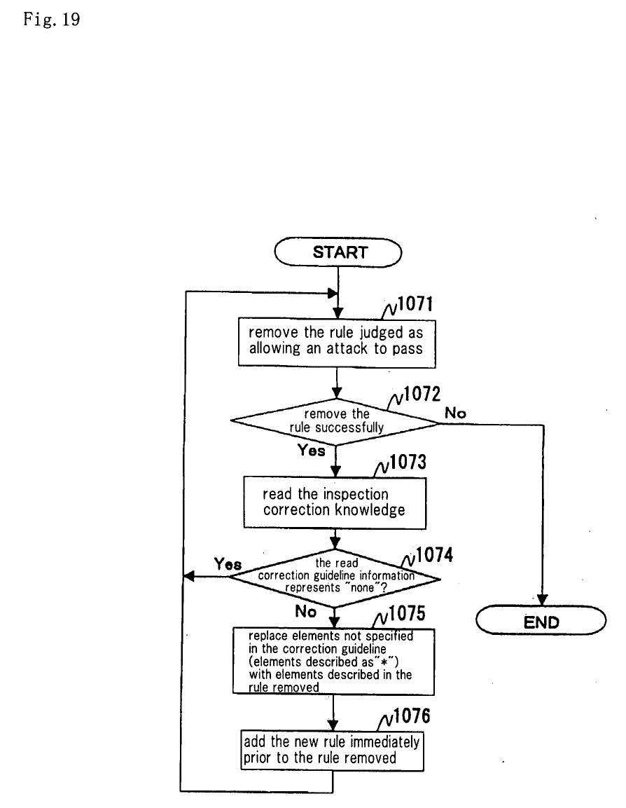

Using the above inspection correction knowledge, FW inspection corrector 270 corrects the non-unique policy after it has been inspected (after step 1006) (step 1006a shown in FIG. 7). FIG. 19 is a flowchart of a process of correcting a non-inherent policy (step 1006a). The process of correcting a non-inherent policy included in an inspected result will be described below with respect to an example in which the inspected result shown in FIG. 15 is obtained by the inspection in step 1006.

FW inspection corrector 270 removes one rule which has been determined as allowing an attack (inspection packet) to pass from the inspected result in step 1006 (step 1071). In step 1071, FW inspection corrector 270 may remove a rule with an attack title added thereto. In the present example, when control goes to step 1071 for the first time, FW inspection corrector 270 removes the rule in the 03th line. Then, FW inspection corrector 270 determines whether it has removed the rule successfully or not (step 1072). If FW inspection corrector 270 has already removed all the rules which have been determined as allowing an attack to pass, and hence there is no rule to remove, then FW inspection corrector 270 judges that it has failed to remove a rule, and the process is brought to an end.

If FW inspection corrector 270 judges it has successfully removed the rule which has been determined as allowing an attack to pass, then control goes to step 1073. In step 1073, FW inspection corrector 270 reads the correction guideline information corresponding to the attack title added to the rule, which has been determined as allowing an attack to pass, from inspection correction knowledge DB 280. Since the attack title “Code Red” is added to the rule in the 03rd line shown in FIG. 15, FW inspection corrector 270 reads the correction guideline information corresponding to the attack title (on the correction guideline information included in inspection correction knowledge 281 shown in FIG. 18).

Then, FW inspection corrector 270 determines whether or not the read correction guideline information represents “NONE” (step 1074). If the correction guideline information does not represent “NONE”, then control goes to step 1075. If correction guideline information represents “NONE”, then control goes back to step 1071, and FW inspection corrector 270 repeats the processing operation from step 1071. In the present example, because the correction guideline information included in inspection correction knowledge 281 represents “NONE”, control goes back to step 1071. The processing operation from step 1075 will be described later.

When control goes back to step 1071, FW inspection corrector 270 removes the rule in the 04th line shown in FIG. 15. Since FW inspection corrector 270 has removed the rule successfully (Yes in step 1072), FW inspection corrector 270 reads the correction guideline information corresponding to “SQL Slammer” added to the rule in the 04th line (step 1073). Herein, FW inspection corrector 270 reads the correction guideline information included in inspection correction knowledge 281 shown in FIG. 18. Because the correction guideline information does not represent “NONE”, control goes to step 1075.

In step 1075, FW inspection corrector 270 replaces elements not specified in the correction guideline (elements described as “*”) with elements described in the rule removed in step 1071. The correction guideline information included in inspection correction knowledge 281 represents “*, *, 1025, 65535, *, *, 1434, 1434, 2, 2, deny”, wherein “SA1 (start source address)”, “SA2 (end source address)”, “DA1 (start destination address)”, and “DA2 (end destination address)” are not specified. In the present example, therefore, FW inspection corrector 270 replaces SA1, SA2, DA1, and DA2 in on the correction guideline information with SA1 (0.0.0.0), SA2 (255.255.255.255), DA1 (192.168.1.4), and DA2 (192.168.1.4) in the rule (0.0.0.0, 255.255.255.255, 1, 65535, 192.168.1.4, 192.168.1.4, 1, 65535, 1, 2, allow) in the 04th line shown in FIG. 15. As a result, the correction guideline information becomes (0.0.0.0, 255.255.255.255, 1025, 65535, 192.168.1.4, 192.168.1.4, 1434, 2, 2, deny).

FW inspection corrector 270 uses the correction guideline information whose unspecified elements have been replaced with the elements of the rule, as a new rule, and adds the new rule immediately prior to the rule removed in step 1071 (step 1076). At this time, FW inspection corrector 270 deletes the information of the attack title added to the rule that was removed in step 1071.

After step 1076, control goes back to step 1071, and FW inspection corrector 270 repeats the processing operation from step 1071. In the present example, because the inspected result shown in FIG. 15 includes no rules which have been determined as allowing an attack to pass in the 05th and following lines, the processing operation is brought to an end.

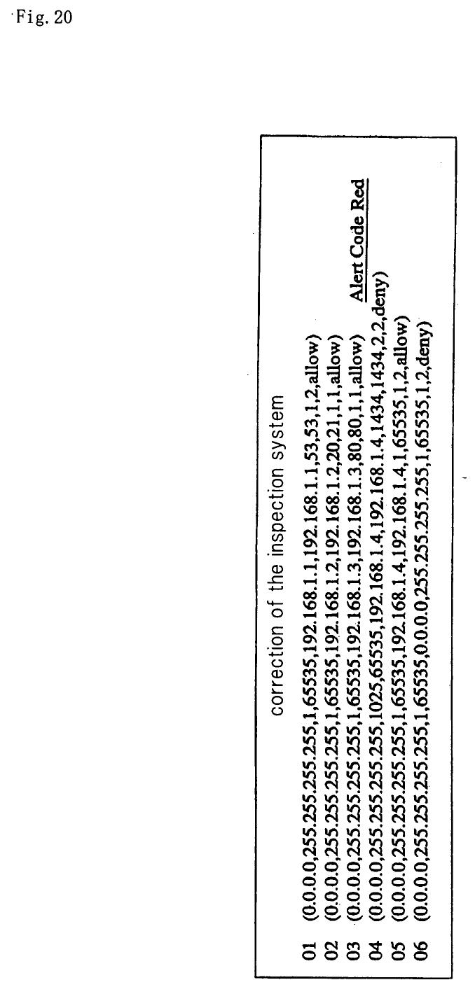

According to the above process, a corrected result of the non-unique policy is obtained. FIG. 20 is a diagram showing an example of a corrected result of the non-inherent policy. The rule in the 05th line in the corrected result of the non-inherent policy shown in FIG. 20 is the same as the rule in the 04th line in the inspected result shown in FIG. 15. The rule in the 04th line in the corrected result of the non-inherent policy shown in FIG. 20 is a new rule generated from the rule which has been determined as allowing an attack to pass and the correction guideline information. Since the new rule in the 04th line shown in FIG. 20 is referred to before the rule in the 05th line which has been determined as allowing an attack to pass, attacking packets are blocked by the rule in the 04th line.

When the correction of the non-unique policy is finished (processing in step 1006a is finished), FW inspection corrector 270 transmits the corrected non-unique policy (corrected result) to communication unit 210 of inspecting system 200. Communication unit 210 transmits the corrected result transmitted from FW inspection corrector 270 to client system 100 (step 1007 shown in FIG. 7).

Communication unit 140 of client system 100 receives the corrected result transmitted from inspecting system 200, and transmits the corrected result to policy applier 170. Communication unit 140 also store the received corrected result in policy memory 130. Alternatively, policy memory 130 may read the corrected result from policy memory 130.

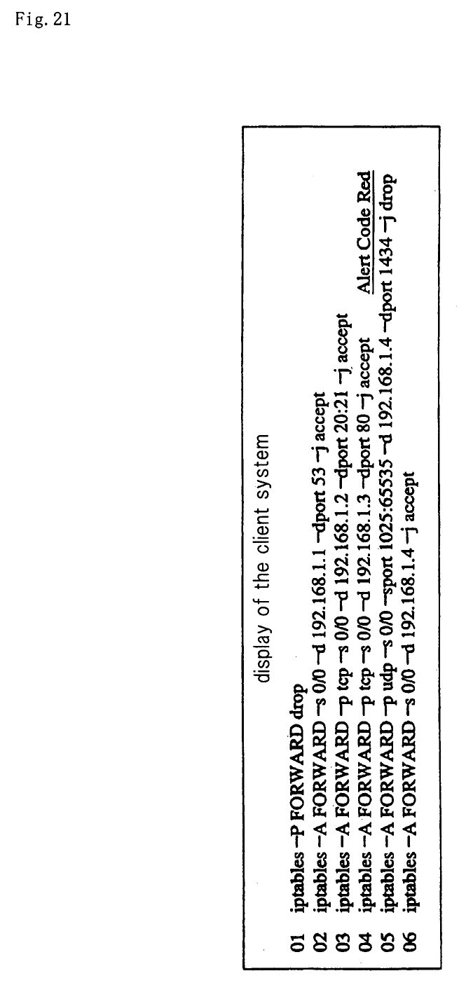

Though not shown in FIG. 20, the number added by communication unit 140 of client system 100 at the time it transmitted the non-unique policy (step 1003) remains added to the corrected result. Based on the number, policy applier 170 identifies information about the type and version of firewall 300, and reads the policy conversion rule that depends on the number and version from policy conversion rule memory 120. Based on the policy conversion rule, policy applier 170 converts the non-unique policy included in the corrected result received from inspecting system 200 into a unique policy. At this time, if an attack title is added to the corrected result, then the attack title is left as it is. As a result, the unique policy converted from the corrected result of the non-unique policy is obtained. An example of the non-unique policy is shown in FIG. 21.

Policy applier 170 controls result output unit 160 to output (e.g., display) the unique policy converted from the corrected result of the non-unique policy. At the same time, policy applier 170 applies the unique policy to firewall 300 (step 1008a shown in FIG. 7). As a result, the firewall policy of firewall 300 is modified so as not to allow attacking packets to pass. Even if on the correction guideline information stored in inspection correction knowledge DB 280 represents “NONE”, since an attack title is displayed together with a rule as shown in the 04th line in FIG. 21, it is possible to present to the client corporation the information indicating which rules allow which attacks to pass.

In the above description, policy applier 170 simultaneously outputs a unique policy and applies the unique policy to firewall 300. However, policy applier 170 may first output a unique policy to prompt the operator of the client corporation to determine whether the unique policy is to be applied to the firewall or not, and may apply the unique policy to firewall 300 if an instruction to apply the unique policy to the firewall is entered from the input device (not shown).

In the above specific example, non-unique policies and corrected results that are exchanged between communication unit 140 of client system 100 and communication unit 210 of inspecting system 200 are transmitted and received as plaintext on Internet 400. However, communication unit 140 of client system 100 may encrypt a non-unique policy and transmit the encrypted non-unique policy, and communication unit 210 of inspecting system 200 may decrypt the received non-unique policy. Similarly, communication unit 210 of inspecting system 200 may encrypt a corrected result, and communication unit 140 of client system 100 may decrypt the received corrected result. Such a configuration can enhance the secrecy of non-unique policies and corrected results that are transmitted and received.

1. A firewall inspecting system comprising:
policy extracting means for extracting a firewall policy which represents a collection of rules representing conditions for allowing packets to pass and conditions for blocking packets, from a firewall;
converting means for converting the firewall policy extracted by said policy extracting means into a non-unique policy which is a firewall policy in a format that is independent of the type of the firewall;
inspection knowledge memory means for storing an inspection packet which is a packet used in an attack or a packet used in an attack which is exclusive of an attack code;
determining process executing means for executing a determining process to determine whether a given packet is allowed to pass or blocked based on said non-unique policy;
virtual firewall generating means for generating a virtual firewall which is a program for enabling said determining process executing means to execute said determining process, using the non-unique policy converted by said converting means;
inspecting means for reading the inspection packet from said inspection knowledge memory means, for controlling said determining process executing means to determine whether said inspection packet is allowed to pass or blocked according to said virtual firewall, and for obtaining a determined result and a rule which has led to said determined result; and
inspected result generating means for generating an inspected result by adding predetermined information to the rule which has led to the determined result indicating that the inspection packet is allowed to pass, among rules included in the non-unique policy converted by said converting means.

2. The firewall inspecting system according to claim 1, further comprising:
inverse converting means for converting the non-unique policy included in the inspected result into a firewall policy in a format that depends on the type of the firewall; and
result output means for outputting the firewall policy converted by said inverse converting means, together with the predetermined information.

3. The firewall inspecting system according to claim 2, wherein said policy extracting means, said converting means, said inverse converting means, and said result output means make up a firewall information extracting system for extracting a firewall policy from a firewall, and said inspection knowledge memory means, said determining process executing means, said virtual firewall generating means, said inspecting means, and said inspected result generating means make up an inspecting system for inspecting said firewall.

4. The firewall inspecting system according to claim 2, wherein said policy extracting means and said result output means make up a firewall information extracting system for extracting a firewall policy from a firewall, and said converting means, said inspection knowledge memory means, said determining process executing means, said virtual firewall generating means, said inspecting means, said inspected result generating means, and said inverse converting means make up an inspecting system for inspecting said firewall.

5. The firewall inspecting system according to claim 1, wherein said determining process executing means determines whether said inspection packet is allowed to pass or not, based on whether or not attribute information stored in a portion of said inspection packet other than a payload thereof is in accordance with a rule in the non-unique policy.

6. A firewall inspecting system comprising:
policy extracting means for extracting a firewall policy which represents a collection of rules representing conditions for allowing packets to pass and conditions for blocking packets, from a firewall;
converting means for converting the firewall policy extracted by said policy extracting means into a non-unique policy which is a firewall policy in a format that is independent of the type of the firewall;
inspection correction knowledge memory means for storing an inspection packet which is a packet used in an attack or a packet used in an attack which is exclusive of an attack code, and correction guideline information for correcting a rule which allows said inspection packet to pass in order to block said inspection packet;
determining process executing means for executing a determining process to determine whether a given packet is allowed to pass or blocked based on said non-unique policy;
virtual firewall generating means for generating a virtual firewall which is a program for enabling said determining process executing means to execute said determining process, using the non-unique policy converted by said converting means;
inspecting means for reading the inspection packet from said inspection correction knowledge memory means, for controlling said determining process executing means to determine whether said inspection packet is allowed to pass or blocked according to said virtual firewall, and for obtaining a determined result and a rule which has led to said determined result;
inspected result generating means for generating an inspected result by adding predetermined information to the rule, which has led to the determined result indicating that the inspection packet is allowed to pass, among rules included in the non-unique policy converted by said converting means; and
correcting means for generating a rule for blocking said inspection packet based on the rule which has led to the determined result indicating that the inspection packet is allowed to pass, and on the correction guideline information corresponding to said inspection packet, and for correcting the non-unique policy by adding said rule to said non-unique policy.

7. The firewall inspecting system according to claim 6, further comprising:
inverse converting means for converting the corrected non-unique policy into a firewall policy in a format that depends on the type of the firewall; and
result output means for outputting the firewall policy converted by said inverse converting means.

8. The firewall inspecting system according to claim 7, wherein said policy extracting means, said converting means, said inverse converting means, and said result output means make up a firewall information extracting system for extracting a firewall policy from a firewall, and said inspection correction knowledge memory means, said determining process executing means, said virtual firewall generating means, said inspecting means, said inspected result generating means, and said correcting means make up an inspecting system for inspecting said firewall.

9. The firewall inspecting system according to claim 7, wherein said policy extracting means and said result output means make up a firewall information extracting system for extracting a firewall policy from a firewall, and said converting means, said inspection correction knowledge memory means, said determining process executing means, said virtual firewall generating means, said inspecting means, said inspected result generating means, said correcting means, and said inverse converting means make up an inspecting system for inspecting said firewall.

10. The firewall inspecting system according to claim 7, further comprising policy applying means for applying the firewall policy converted by said inverse converting means to the firewall.

11. The firewall inspecting system according to claim 10, further comprising:
non-unique policy memory means for storing the non-unique policy converted by said converting means; and
instruction input means for entering an instruction to reapply the firewall policy to the firewall;
wherein when said instruction is entered, said inverse converting means converts the non-unique policy stored by said non-unique policy memory means in the firewall policy in the format that depends on the type of the firewall, and said policy applying means applies the firewall policy converted by said inverse converting means to the firewall.

12. The firewall inspecting system according to claim 6, wherein said determining process executing means determines whether said inspection packet is allowed to pass or not based on whether or not attribute information stored in a portion of said inspection packet other than a payload thereof is in accordance with a rule in the non-unique policy.

13. A firewall information extracting system for extracting a firewall policy which represents a collection of rules representing conditions for allowing packets to pass and conditions for blocking packets, from a firewall, said firewall information extracting system comprising:
policy extracting means for extracting a firewall policy from a firewall;
converting means for converting the firewall policy extracted by said policy extracting means into a non-unique policy which is a firewall policy in a format that is independent of the type of the firewall;
non-unique policy transmitting means for transmitting the non-unique policy converted by said converting means to an inspecting system for inspecting the firewall to enable said inspecting system to inspect the firewall; and
inspected result receiving means for receiving, from said inspecting system, an inspected result that is generated by adding predetermined information to a rule which allows an inspection packet to pass, among rules included in said non-unique policy.

14. The firewall information extracting system according to claim 13, further comprising:
inverse converting means for converting the non-unique policy included in the inspected result in a firewall policy in a format that depends on the type of the firewall; and
result output means for outputting the firewall policy converted by said inverse converting means, together with the predetermined information.

15. A firewall information extracting system for extracting a firewall policy, which represents a collection of rules representing conditions for allowing packets to pass and conditions for blocking packets, from a firewall, said system comprising:
policy extracting means for extracting a firewall policy from a firewall;
converting means for converting the firewall policy extracted by said policy extracting means into a non-unique policy which is a firewall policy in a format that is independent of the type of the firewall;
non-unique policy transmitting means for transmitting the non-unique policy converted by said converting means to an inspecting system for inspecting the firewall to enable said inspecting system to correct said non-unique policy; and
corrected result receiving means for receiving the corrected non-unique policy from said inspecting system.

16. A firewall information extracting system according to claim 15, further comprising:
inverse converting means for converting the corrected non-unique policy iton a firewall policy in a format that depends on the type of the firewall; and
result output means for outputting the firewall policy converted by said inverse converting means.

17. The firewall information extracting system according to claim 16, further comprising policy applying means for applying the firewall policy converted by said inverse converting means to the firewall.

18. The firewall information extracting system according to claim 17, further comprising:
non-unique policy memory means for storing the non-unique policy converted by said converting means; and
instruction input means for entering an instruction to reapply the firewall policy to the firewall;
wherein when said instruction is entered, said inverse converting means converts the non-unique policy stored by said non-unique policy memory means into the firewall policy in a format that depends on the type of the firewall, and said policy applying means applies the firewall policy converted by said inverse converting means to the firewall.

19. A firewall inspecting system for inspecting a firewall by receiving data from a firewall information extracting system for extracting a firewall policy from the firewall, said firewall inspecting system comprising:
non-unique policy receiving means for receiving a non-unique policy, which is a firewall policy in a format that is independent of the type of the firewall, from said firewall information extracting system;
inspection knowledge memory means for storing an inspection packet which is a packet used in an attack or a packet used in an attack which is exclusive of an attack code;
determining process executing means for executing a determining process to determine whether a given packet is allowed to pass or blocked based on said non-unique policy;
virtual firewall generating means for generating a virtual firewall which is a program for enabling said determining process executing means to execute said determining process, using the non-unique policy received by said non-unique policy receiving means;
inspecting means for reading the inspection packet from said inspection knowledge memory means, for controlling said determining process executing means to determine whether said inspection packet is allowed to pass or blocked according to said virtual firewall, and for obtaining a determined result and a rule which has led to said determined result;
inspected result generating means for generating an inspected result by adding predetermined information to the rule, which has led to the determined result indicating that the inspection packet is allowed to pass, among rules included in the non-unique policy received by said non-unique policy receiving means; and
inspected result transmitting means for transmitting said inspected result to said firewall information extracting system.

20. A firewall inspecting system for inspecting a firewall by receiving data from a firewall information extracting system for extracting a firewall policy from the firewall, said firewall inspecting system comprising:
policy receiving means for receiving said firewall policy from said firewall information extracting system;
converting means for converting the firewall policy received by said policy receiving means into a non-unique policy which is a firewall policy in a format that is independent of the type of the firewall;
inspection knowledge memory means for storing an inspection packet which is a packet used in an attack or a packet used in an attack which is exclusive of an attack code;
determining process executing means for executing a determining process to determine whether a given packet is allowed to pass or blocked, based on said non-unique policy;
virtual firewall generating means for generating a virtual firewall which is a program for enabling said determining process executing means to execute said determining process, using the non-unique policy converted by said converting means;
inspecting means for reading the inspection packet from said inspection knowledge memory means, for controlling said determining process executing means to determine whether said inspection packet is allowed to pass or blocked according to said virtual firewall, and for obtaining a determined result and a rule which has led to said determined result; and
inspected result generating means for generating an inspected result by adding predetermined information to the rule, which has led to the determined result indicating that the inspection packet is allowed to pass, among rules included in the non-unique policy converted by said converting means.

21. The firewall inspecting system according to claim 20, further comprising:
inverse converting means for converting the non-unique policy included in the inspected result into a firewall policy in a format that depends on the type of the firewall; and
result output means for outputting the firewall policy converted by said inverse converting means, together with the predetermined information.

22. A firewall inspecting system for inspecting a firewall by receiving data from a firewall information extracting system for extracting a firewall policy from the firewall, said firewall inspecting system comprising:
non-unique policy receiving means for receiving a non-unique policy, which is a firewall policy in a format that is independent of the type of the firewall, from said firewall information extracting system;
inspection correction knowledge memory means for storing an inspection packet which is a packet used in an attack or a packet used in an attack which is exclusive of an attack code, and correction guideline information for correcting a rule which allows said inspection packet to pass in order to block said inspection packet;
determining process executing means for executing a determining process to determine whether a given packet is allowed to pass or blocked based on said non-unique policy;
virtual firewall generating means for generating a virtual firewall which is a program for enabling said determining process executing means to execute said determining process, using the non-unique policy received by said non-unique policy receiving means;
inspecting means for reading the inspection packet from said inspection correction knowledge memory means, for controlling said determining process executing means to determine whether said inspection packet is allowed to pass or blocked according to said virtual firewall, and for obtaining a determined result and a rule which has led to said determined result;
inspected result generating means for generating an inspected result by adding predetermined information to the rule, which has led to the determined result indicating that the inspection packet is allowed to pass, among rules included in the non-unique policy received by said non-unique policy receiving means;
correcting means for generating a rule for blocking said inspection packet based on the rule which has led to the determined result indicating that the inspection packet is allowed to pass, and on the correction guideline information corresponding to said inspection packet, and for correcting the non-unique policy by adding said rule to said non-unique policy; and
corrected result transmitting means for transmitting the corrected non-unique policy to said firewall information extracting system.

23. A firewall inspecting system for inspecting a firewall by receiving data from a firewall information extracting system for extracting a firewall policy from the firewall, said firewall inspecting system comprising:
policy receiving means for receiving said firewall policy from said firewall information extracting system;
converting means for converting the firewall policy received by said policy receiving means into a non-unique policy which is a firewall policy in a format that is independent of the type of the firewall;
inspection correction knowledge memory means for storing an inspection packet which is a packet used in an attack or a packet used in an attack which is exclusive of an attack code, and correction guideline information for correcting a rule which allows said inspection packet to pass in order to block said inspection packet;
determining process executing means for executing a determining process to determine whether a given packet is allowed to pass or blocked based on said non-unique policy;
virtual firewall generating means for generating a virtual firewall which is a program for enabling said determining process executing means to execute said determining process, using the non-unique policy converted by said converting means;
inspecting means for reading the inspection packet from said inspection correction knowledge memory means, for controlling said determining process executing means to determine whether said inspection packet is allowed to pass or blocked according to said virtual firewall, and for obtaining a determined result and a rule which has led to said determined result;
inspected result generating means for generating an inspected result by adding predetermined information to the rule which has led to the determined result indicating that the inspection packet is allowed to pass, among rules included in the non-unique policy received by said non-unique policy receiving means; and
correcting means for generating a rule for blocking said inspection packet based on the rule which has led to the determined result indicating that the inspection packet is allowed to pass, and on the correction guideline information corresponding to said inspection packet, and for correcting the non-unique policy by adding said rule to said non-unique policy.

24. The firewall inspecting system according to claim 23, further comprising:
inverse converting means for converting the corrected non-unique policy into a firewall policy in a format that depends on the type of the firewall; and
corrected policy transmitting means for transmitting the firewall policy converted by said inverse converting means to said firewall information extracting system.

25. The firewall inspecting system according to claim 19, wherein said determining process executing means determines whether said inspection packet is allowed to pass or not, based on whether or not attribute information stored in a portion of said inspection packet other than a payload thereof is in accordance with a rule in the non-unique policy.

26. A firewall information extracting program for enabling a computer to perform:
a process of extracting a firewall policy which represents a collection of rules representing conditions for allowing packets to pass and conditions for blocking packets, from a firewall;
a process of converting the extracted firewall policy into a non-unique policy which is a firewall policy in a format that is independent of the type of the firewall;
a process of transmitting said non-unique policy to an inspecting system for inspecting a firewall; and
a process of receiving, from said inspecting system, an inspected result generated by adding predetermined information to a rule which allows an inspection packet to pass, among rules included in said non-unique policy.

27. The firewall information extracting program according to claim 26, wherein the firewall information extracting program further enables the computer to perform:
a process of converting the non-unique policy included in the inspected result into a firewall policy in a format that depends on the type of the firewall; and
a process of outputting said firewall policy together with the predetermined information.

28. A firewall information extracting program for enabling a computer to perform:
a process of extracting a firewall policy which represents a collection of rules representing conditions for allowing packets to pass and conditions for blocking packets, from a firewall;
a process of converting the extracted firewall policy into a non-unique policy which is a firewall policy in a format that is independent of the type of the firewall;
a process of transmitting said non-unique policy to an inspecting system for inspecting a firewall; and
a process of receiving a corrected non-unique policy from said inspecting system.

29. The firewall information extracting program according to claim 28, wherein the firewall information extracting program further enables the computer to perform:
a process of converting the corrected non-unique policy into a firewall policy in a format that depends on the type of the firewall; and
a process of outputting said firewall policy.

30. A firewall inspecting program installed in a computer for inspecting a firewall by receiving data from a firewall information extracting system for extracting a firewall policy from the firewall, said firewall information extracting system having inspection knowledge memory means for storing an inspection packet which is a packet used in an attack or a packet used in an attack which is exclusive of an attack code, said firewall inspecting program enabling said computer to perform:
a process of receiving a non-unique policy which is a firewall policy in a format that is independent of the type of the firewall, from said firewall information extracting system;
a process of generating, using the received non-unique policy, a virtual firewall which is a program for enabling determining process executing means for executing a determining process to determine whether a given packet is allowed to pass or blocked, based on said non-unique policy to execute said determining process;
a process of reading the inspection packet from said inspection knowledge memory means, controlling said determining process executing means to determine whether said inspection packet is allowed to pass or blocked according to said virtual firewall, and obtaining a determined result and a rule which has led to said determined result;
a process of generating an inspected result by adding predetermined information to the rule which has led to the determined result indicating that the inspection packet is allowed to pass, among rules included in the received non-unique policy; and
a process of transmitting said inspected result to said firewall information extracting system.

31. A firewall inspecting program installed in a computer for inspecting a firewall by receiving data from a firewall information extracting system for extracting a firewall policy from the firewall, said firewall information extracting system having inspection knowledge memory means for storing an inspection packet which is a packet used in an attack or a packet used in an attack which is exclusive of an attack code, said firewall inspecting program enabling said computer to perform:
a process of receiving said firewall policy from said firewall information extracting system;
a process of converting the received firewall policy into a non-unique policy which is a firewall policy in a format that is independent of the type of the firewall;
a process of generating, using the converted non-unique policy, a virtual firewall which is a program for enabling determining process executing means for executing a determining process to determine whether a given packet is allowed to pass or blocked, based on said non-unique policy to execute said determining process;
a process of reading the inspection packet from said inspection knowledge memory means, controlling said determining process executing means to determine whether said inspection packet is allowed to pass or blocked according to said virtual firewall, and obtaining a determined result and a rule which has led to said determined result; and
a process of generating an inspected result by adding predetermined information to the rule which has led to the determined result indicating that the inspection packet is allowed to pass, among rules included in the converted non-unique policy.

32. The firewall inspecting program according to claim 31, wherein the firewall inspecting program further enables the computer to perform:
a process of converting the non-unique policy included in said inspected result into a firewall policy in a format that depends on the type of the firewall; and
a process of transmitting said firewall policy together with the predetermined information to the firewall information extracting system.

33. A firewall inspecting program installed in a computer for inspecting a firewall by receiving data from a firewall information extracting system for extracting a firewall policy from the firewall, said firewall information extracting system having inspection correction knowledge memory means for storing an inspection packet which is a packet used in an attack or a packet used in an attack which is exclusive of an attack code, and correction guideline information for correcting a rule which allows said inspection packet to pass in order to block said inspection packet, said firewall inspecting program enabling said computer to perform:
a process of receiving a non-unique policy which is a firewall policy in a format that is independent of the type of the firewall, from said firewall information extracting system;
a process of generating, using the received non-unique policy, a virtual firewall which is a program for enabling determining process executing means for executing a determining process to determine whether a given packet is allowed to pass or blocked, based on said non-unique policy to execute said determining process;
a process of reading the inspection packet from said inspection correction knowledge memory means, controlling said determining process executing means to determine whether said inspection packet is allowed to pass or blocked according to said virtual firewall, and obtaining a determined result and a rule which has led to said determined result;
a process of generating an inspected result by adding predetermined information to the rule which has led to the determined result indicating that the inspection packet is allowed to pass, among rules included in the received non-unique policy;
a process of generating a rule for blocking said inspection packet based on the rule which has led to the determined result indicating that the inspection packet is allowed to pass, and on the correction guideline information corresponding to said inspection packet, and correcting the non-unique policy by adding said rule to said non-unique policy; and
a process of transmitting the corrected non-unique policy to said firewall information extracting system.

34. A firewall inspecting program installed in a computer for inspecting a firewall by receiving data from a firewall information extracting system for extracting a firewall policy from the firewall, said firewall information extracting system having inspection correction knowledge memory means for storing an inspection packet which is a packet used in an attack or a packet used in an attack which is exclusive of an attack code, and correction guideline information for correcting a rule which allows said inspection packet to pass in order to block said inspection packet, said firewall inspecting program enabling said computer to perform:
a process of receiving said firewall policy from said firewall information extracting system;
a process of converting the received firewall policy into a non-unique policy which is a firewall policy in a format that is independent of the type of the firewall;
a process of generating, using the converted non-unique policy, a virtual firewall which is a program for enabling determining process executing means for executing a determining process to determine whether a given packet is allowed to pass or blocked, based on said non-unique policy to execute said determining process;
a process of reading the inspection packet from said inspection correction knowledge memory means, controlling said determining process executing means to determine whether said inspection packet is allowed to pass or blocked according to said virtual firewall, and obtaining a determined result and a rule which has led to said determined result;
a process of generating an inspected result by adding predetermined information to the rule which has led to the determined result indicating that the inspection packet is allowed to pass, among rules included in the converted non-unique policy; and
a process of generating a rule for blocking said inspection packet based on the rule which has led to the determined result indicating that the inspection packet is allowed to pass, and on the correction guideline information corresponding to said inspection packet, and correcting the non-unique policy by adding said rule to said non-unique policy.

35. The firewall inspecting program according to claim 34, wherein the firewall inspecting program further enables the computer to perform:
a process of converting the corrected non-unique policy into a firewall policy in a format that depends on the type of the firewall; and
a process of transmitting said firewall policy to the firewall information extracting system.
